(19) United States
(12) Patent Application Publication
(10) Pub. No.: US 2011/0116662 A1
(43) Pub. Date: May 19, 2011

(54) SPEAKER DEVICE

(75) Inventors: Kazuki Yuze, Yamagata (JP); Hiroyuki Kobayashi, Yamagata (JP); Koji Takayama, Yamagata (JP); Akihiko Furuto, Yamagata (JP); Shintaro Niidera, Yamagata (JP); Toshihiro Hikichi, Yamagata (JP)

(73) Assignees: PIONEER CORPORATION, Tokyo (JP); TOHOKU PIONEER CORPORATION, Yamagata (JP)

(21) Appl. No.: 13/002,802

(22) PCT Filed: Jul. 10, 2008
(86) PCT No.: PCT/JP2008/062513

§ 371 Date: Jan. 6, 2011

(51) Int. Cl. H04R 9/06

(52) U.S. Cl. 381/184; 381/185

(57) ABSTRACT

A speaker device includes a vibrating body including a diaphragm and a voice coil supported by a part of the diaphragm and a magnetic circuit including a first magnetic pole part having a magnet and a second magnetic pole part different from the first magnetic pole part and arranged spaced apart from the first magnetic pole part. The voice coil is arranged between the first magnetic pole part and the second magnetic pole part, the vibrating body includes a conducting part formed at a part or whole of the diaphragm, in the proximity of the voice coil, and the conducting part is arranged between the first magnetic pole part and the second magnetic pole part.

### FIELD OF THE INVENTION

The present invention relates to a speaker device.

### BACKGROUND OF THE INVENTION

An electrodynamic loudspeaker is known in which, when a signal current is applied to a movable coil arranged in a static magnetic field, the movable coil vibrates and the diaphragm vibrates (for example, see patent literature 1). A common electrodynamic loudspeaker 1J, for example, includes a magnetic circuit 2J, and a vibrating body 3J as shown in FIG. 1. In the magnetic circuit 2J, a magnet 22J is arranged on a yoke 21J having a U-shaped cross section and a plate 23J is arranged on the magnet 22J, and a magnetic gap is formed between the plate 23J and the yoke 21J. A voice coil 31J is arranged in the magnetic gap and the voice coil 31J is joined to a voice coil bobbin 32J. The voice coil bobbin 32J is joined to a diaphragm 33J and the outer periphery part of the diaphragm 33J is vibratably joined to a frame 35J via an edge 34J.

[Patent literature] Publication of unexamined patent application 2005-102166

### DISCLOSURE OF THE INVENTION

### Problems to be Solved by the Invention

In the above electrodynamic loudspeaker 1J, the voice coil 31J is joined to the inner periphery part (or outer periphery part) of the diaphragm 33J via the voice coil bobbin 32J, and the driving force of the voice coil is transmitted to the diaphragm 33J via the connecting part (voice coil bobbin 32J included) joining the voice coil 31J and the diaphragm 33J. A common diaphragm 33J, which is formed with paper or resin, is not a perfect rigid body and has an internal loss. As such, the further the position on the diaphragm 33J is from the voice coil 31J, the more difficult is the driving force transmitted thereto from the voice coil 31J. Further, the higher a frequency of the voice coil 31J is when the voice coil vibrates, the more depressed is the driving force acted on the diaphragm 33J. More specifically, in the above electrodynamic loudspeaker 1J, it is difficult that the whole diaphragm vibrates in the same phase as the vibration of the voice coil 31J.

Further, according to the above electrodynamic loudspeaker 1J, since a frequency characteristic of output sound pressure depends on the phase of a sound wave emitted from the diaphragm, the frequency characteristic of output sound pressure can hardly be flattened from low frequency range to high frequency range. Accordingly, speaker device with a high sound quality, in which the voice coil and the diaphragm vibrate substantially in the same phase, is desired.

In addition, the above speaker 1J including comparatively a large number of configuration components, the cost for manufacturing is comparatively high and the manufacturing man-hours are comparatively large. Accordingly, a speaker device with simply configuration and high sound quality is desired.

Further, according to a common electrodynamic loudspeaker 1J, the diaphragm is formed in a shape that a half apex angle of the diaphragm is comparatively small to improve a characteristic at high frequency range. Accordingly, in the electrodynamic loudspeaker 1J shown in FIG. 1, the height (HJ) of the diaphragm 33J is comparatively large, and the whole height of the speaker 1J is comparatively large.

It is an object of the present invention to overcome the problem described above. That is, an object of the present invention is to provide a speaker device capable of vibrating the diaphragm and the voice coil substantially in the same phase, a speaker device with high sound quality and comparatively high sound pressure, a speaker device with high sound quality and comparatively simple configuration and a thin speaker device with high sound quality.

### Means for Solving the Problems

To achieve the above-mentioned object, a speaker device according to the present invention has at least a configuration according to the following independent claim.

A speaker device according to the present invention includes:

a vibrating body including a diaphragm and a voice coil supported by a part of the diaphragm; and

a magnetic circuit including a first magnetic pole part having a magnet and a second magnetic pole part different from the first magnetic pole part, the first magnetic pole and the second magnetic pole are arranged spaced apart; wherein

the voice coil is arranged between the first magnetic pole part and the second magnetic pole part, and

the vibrating body includes a conducting part formed at a part or whole of the diaphragm, in the proximity of the voice coil, and

the conducting part is arranged between the first magnetic pole part and the second magnetic pole part.

A speaker device according to the present invention includes: a vibrating body including a diaphragm and a voice coil supported by a part of the diaphragm; and a magnetic circuit including a first and a second magnetic pole parts and a third and a forth magnetic pole parts different from the first and the second magnetic pole parts, wherein the first and the second magnetic pole parts are formed at both ends of a magnet, and the first and second magnetic pole parts are arranged spaced apart, wherein the voice coil is arranged between the second magnetic pole part and the fourth magnetic pole part, and the vibrating body includes a conducting part formed at a part or whole of the diaphragm, in the proximity of the voice coil, and the conducting part is arranged between the first magnetic pole part and the third magnetic pole part.

### BRIEF DESCRIPTION OF THE DRAWINGS

FIG. 1 is a cross-sectional view of a speaker device according to a prior art.

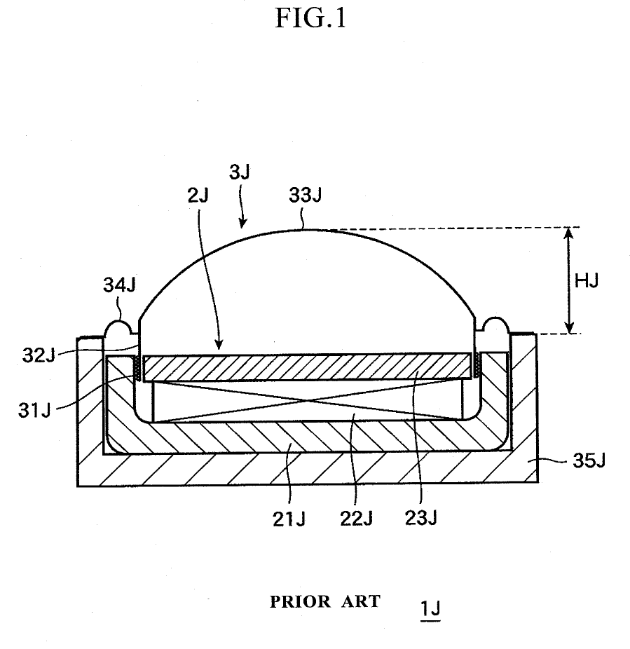

FIG. 2(A) is a front view of the speaker device according to a first embodiment of the present invention and FIG. 2(B) is a cross-sectional view taken along line A-A′ of the speaker device 1 shown in FIG. 2(A).

FIG. 3(A) is a cross-sectional view illustrating the operation of the speaker device 1 shown in FIGS. 2(A) and 2(B), and FIG. 3(B) is a view illustrating the operation of the conducting part 335 of the diaphragm 33.

FIG. 4(A) is a cross-sectional view of an annular conducting part 335 with a large-size outer diameter provided at the voice coil 31 and the diaphragm 33, FIG. 4(B) is a cross-sectional view of a conducting part 335 with a medium-size outer diameter, and FIG. 4(C) is a cross-sectional view of an annular conducting part 335 with a small-size outer diameter.

FIG. 5(A) is a view illustrating impedance of a speaker, electrical coupling coefficient between a voice coil of a speaker and a conducting part, and respective frequency characteristic. FIG. 5(B) is a view of an equivalent circuit illustrating an operation of a speaker according to the present invention.

FIG. 6(A) is a view illustrating a sound pressure frequency characteristic of the speaker device 1 according to an embodiment of the present invention and FIG. 6(B) is a view illustrating a sound pressure frequency characteristic of the speaker device 1 according to a comparative example.

FIG. 7(A) is a front view of the speaker device according to a second embodiment of the present invention and FIG. 7(B) is a cross-sectional view taken along line A-A′ of the speaker device 1 shown in FIG. 7(A).

FIG. 8 is a cross-sectional view of the speaker device 1B according to a third embodiment of the present invention.

FIG. 9 is a cross-sectional view of the speaker device 1C according to a fourth embodiment of the present invention.

FIG. 10 is a cross-sectional view of the speaker device 1D according to a fifth embodiment of the present invention.

FIG. 11 is a cross-sectional view of the speaker device 1E according to a sixth embodiment of the present invention.

FIG. 12 is a cross-sectional view of the speaker device 1F according to a seventh embodiment of the present invention.

FIG. 13 is a cross-sectional view of the speaker device 1G according to an eighth embodiment of the present invention.

FIG. 14 is a cross-sectional view of the speaker device 1H according to a ninth embodiment of the present invention.

FIG. 15 is a cross-sectional view of the speaker device 1K according to a tenth embodiment of the present invention.

FIG. 16 is a cross-sectional view of the speaker device 1L according to an eleventh embodiment of the present invention.

FIG. 17 is a cross-sectional view of the speaker device 1M according to a twelfth embodiment of the present invention.

FIG. 18 is a cross-sectional view of the speaker device 1N according to a thirteenth embodiment of the present invention.

FIG. 19 is a cross-sectional view of the speaker device 1P according to a fourteenth embodiment of the present invention.

FIG. 20 is a cross-sectional view of the speaker device 1Q according to a fifteenth embodiment of the present invention.

FIG. 21 is a cross-sectional view of the speaker device 1R according to a sixteenth embodiment of the present invention.

FIG. 22 is a cross-sectional view of the speaker device 1S according to a seventeenth embodiment of the present invention.

### DESCRIPTION OF SYMBOLS

1 speaker device

2 magnetic circuit

3 vibrating body

4 support member (frame)

21 yoke

22 magnet

23 plate (pole piece)

31 voice coil

33 diaphragm

34 edge

335 335 conducting part

### BEST MODE OF THE INVENTION

A speaker device according to an embodiment of the present invention includes: a vibrating body including a diaphragm and a voice coil supported by a part of the diaphragm; and a magnetic circuit including a first magnetic pole part having a magnet and a second magnetic pole part different from the first magnetic pole part, the first magnetic pole and the second magnetic pole are arranged spaced apart; wherein the voice coil is arranged between the first magnetic pole part and the second magnetic pole part, and the vibrating body includes a conducting part formed at a part or whole of the diaphragm, in the proximity of the voice coil, and the conducting part is arranged between the first magnetic pole part and the second magnetic pole part.

More specifically, according to the above speaker device, a part or whole of the diaphragm is arranged between the first magnetic pole part and the second magnetic pole part, and the conducting part is provided at a part of the diaphragm arranged between the first magnetic pole part and the second magnetic pole part, and the conducting part is provided in the proximity of the voice coil. A static magnetic field is formed in the magnetic gap between the first magnetic pole part and the second magnetic pole part in the magnetic circuit. The voice coil is arranged in the magnetic gap. The voice coil is connected to the diaphragm directly or indirectly via a voice coil support member, (voice coil bobbin) etc.

[First Driving Force]

A Lorentz force is generated in the voice coil in response to a signal current inputted to the voice coil when driving a speaker. The voice coil, subjected to the Lorentz force as a driving force (first driving force), vibrates in the axis direction (sound emission direction) of the voice coil. The driving force (first driving force) generated in the voice coil is transmitted to the diaphragm via a connecting part connecting the voice coil and the diaphragm, and the diaphragm vibrates in response to the driving force.

[Second Driving Force]

Further, in the speaker device according to the present invention, the voice coil and the annular conducting part provided at the diaphragm are electromagnetically coupled by electromagnetic induction.

Upon a signal current (alternating current) inputted to the voice coil when driving a speaker, an alternating magnetic field (also referred to as an alternating flux or a fluctuation flux) is generated around the voice coil. An electromagnetic induction is generated in the annular conducting part provided at the diaphragm by the alternating magnetic field, and thereby an induction current generates in the conducting part. A driving force (second driving force) is generated in the conducting part of the diaphragm in response to a DC magnetic field in the magnetic gap and the induction current. This driving force (second driving force) is directed to substantially the same direction as the Lorentz force (first driving force) generated in the voice coil.

Thus, in the speaker device according to the present invention, a first driving force is generated in the voice coil while a second driving force is generated in the conducting part provided at the diaphragm when driving the speaker. The second driving force is directed in the same direction as the first driving force, and the second driving force has substantially the same phase as the first driving force. As such, the speaker device according to the present invention can emit a sound wave with a high sound quality and a comparatively large sound pressure at comparatively broad frequency range compared to a common speaker device.

Further, the speaker device, according to the present invention, including a conducting part face distributed at a part or whole of the diaphragm, the conducting part of the diaphragm is face driven. As such, the speaker device can emit a sound wave with a comparatively high sound quality from a part or whole of the diaphragm.

As described above, the speaker device, according to the present invention, includes an electrodynamic part and an electromagnetic induction part, and the electrodynamic part and the electromagnetic induction part cooperatively work to vibrate the diaphragm (referred to as a hybrid speaker).

Hereinafter, the speaker device according to an embodiment of the present invention is described with reference to the drawings.

### First Embodiment

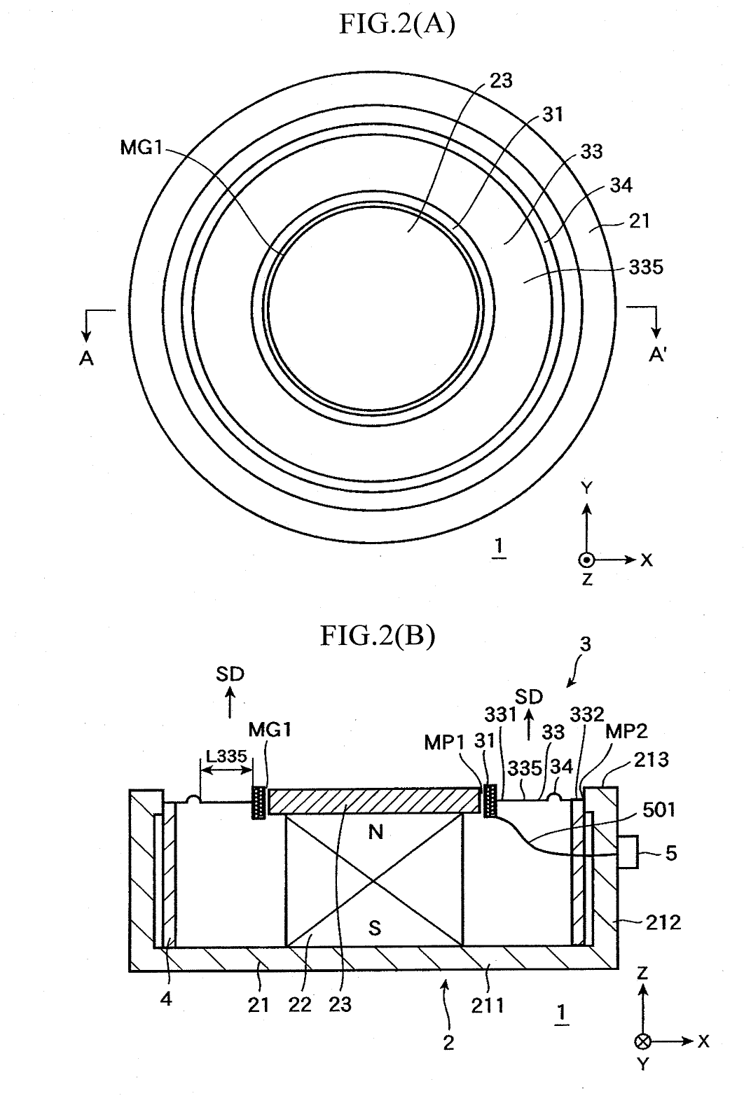

FIG. 2 is a view illustrating a speaker device 1 according to a first embodiment of the present invention. Specifically, FIG. 2(A) is a front view of the speaker device 1 according to a first embodiment of the present invention and FIG. 2(B) is a cross-sectional view taken along line A-A′ of the speaker device 1 shown in FIG. 2(A).

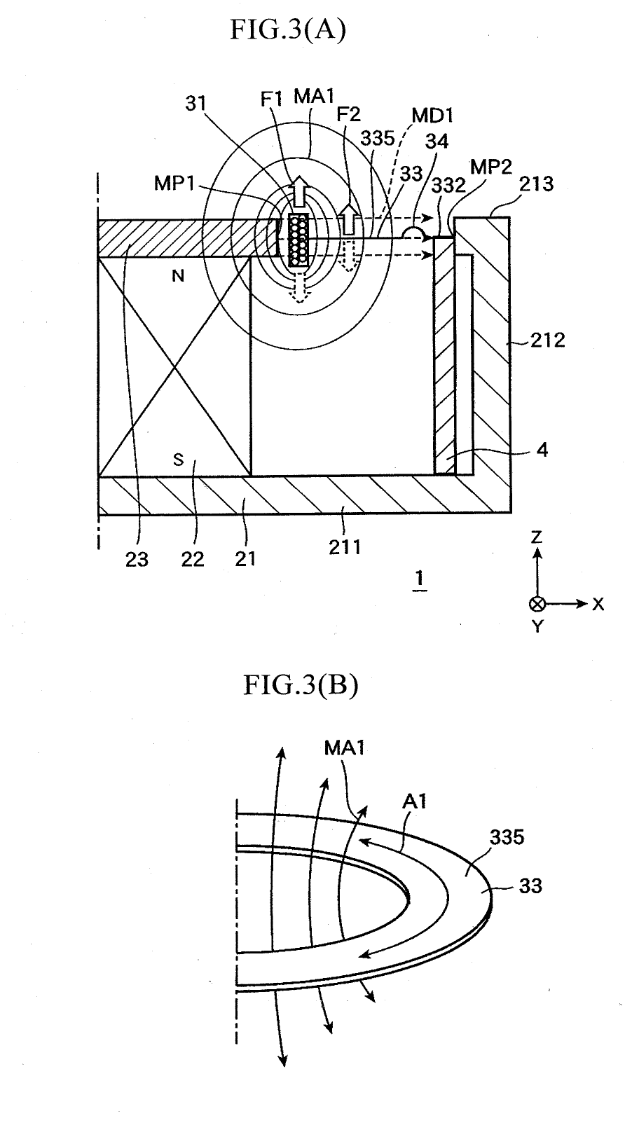

As shown in FIGS. 2(A) and 2(B), the speaker device 1 according to a first embodiment of the present invention includes a magnetic circuit 2, vibrating body 3, and a support member (frame) 4. FIG. 3(A) is a cross-sectional view illustrating an operation of the speaker device 1 shown in FIGS. 2(A) and 2(B), and FIG. 3(B) is a view illustrating an operation of the conducting part 335 of the diaphragm 33.

The magnetic circuit 2 corresponds to an embodiment of the magnetic circuit according to the present invention, the vibrating body 3 corresponds to an embodiment of the vibrating body according to the present invention and the support member (frame) 4 corresponds to an embodiment of the frame according to the present invention.

The speaker device 1 according to this embodiment includes the electrodynamic part and the electromagnetic induction part, and the electrodynamic part and the electromagnetic induction part cooperatively work to vibrate the diaphragm 33. Specifically, the speaker device 1 includes a magnetic gap MG1 between the yoke 21 and the plate (pole piece) 23 in the magnetic circuit 2, and the conducting diaphragm 33 having the conducting part arranged in the DC magnetic field of the magnetic gap MG1.

Hereinafter, respective configuration elements of the speaker device 1 are described.

As the magnetic circuit 2, an inner-magnetic type magnetic circuit, outer-magnetic type magnetic circuit, etc. may be adopted. The magnetic circuit 2 according to this embodiment is an inner-magnetic type magnetic circuit. As shown in FIGS. 2(A) and 2(B), the magnetic circuit 2 includes the yoke 21, the magnet 22 and the plate (pole piece) 23.

The yoke 21 is formed with iron, a magnetic body, etc. The yoke 21 according to this embodiment includes a bottom face part 211, an outer periphery side part (tubular part) 212, and an upper end portion 213 as shown in FIG. 2(B). The bottom face part 211 is formed in a tabular shape. The outer periphery side part 212 is provided at the end of the bottom face part 211. The outer periphery side part (tubular part) 212 is tubularly formed so as to surround the bottom face part 211, and the diaphragm 33 (also referred to as a first vibrating part) is connected to the upper end portion 213 via the edge 34 (also referred to as a second vibrating part or a diaphragm support part). Further, the outer periphery side part 212 according to this embodiment has the upper end portion 213 formed in a shape bending radially inward. The above bottom face part 211, the outer periphery side part 212 and the upper end portion 213 are integrally formed. Further, the above bottom face part 211, the outer periphery side part 212 and the upper end portion 213 may be formed with different members as necessary. The magnet 22 is formed in a pillar shape, specially in a columnar shape in this embodiment. Further, the magnet 22 is arranged on the central part of the yoke 21.

Further, the magnet 22 is magnetized in the axis direction (Z-axis direction, sound emission direction SD). In short, the magnetic body constructing the magnet 22 according to this embodiment is magnetized in the thickness direction. The plate (pole piece) 23 is formed with iron, a magnetic body, etc.

The plate 23 is formed in a tubular shape, and arranged on the magnet 22. Further, as shown in FIGS. 2(A) and 2(B), the magnetic circuit 2 includes a tubular magnetic gap MG1 between the end portion of the plate 23 and the upper end portion 213 of the yoke 21.

In the above magnetic circuit 2, the plate 23 corresponds to an embodiment of the first magnetic pole part (MP1) and the yoke 21 corresponds to an embodiment of the second magnetic pole part (MP2). The magnetic gap MG1 is formed between these first magnetic pole part (MP1) and second magnetic pole part (MP2). Specifically, the first magnetic pole part (MP1) is formed at the end portion of the plate (pole piece) 23, while the second magnetic pole part (MP2) is formed at the end portion of the outer periphery side part 212 of the yoke 21.

More specially, the magnetic circuit 2 includes the first magnetic pole part (MP1) and the second magnetic pole part (MP2). The first magnetic pole part (MP1) is formed with the magnetic body having the magnet 22. The second magnetic pole part (MP2)is different from the first magnetic pole part (MP1)and arranged spaced apart from the first magnetic pole part (MP1) by a prescribed distance.

The vibrating body 3 includes the voice coil 31, diaphragm 33 and the edge 34. The voice coil 31 is supported by the diaphragm 33. Further, the voice coil 31 is arranged between the first magnetic pole part (MP1) and the second magnetic pole part (MP2) (magnetic gap MG1). The voice coil 31 according to this embodiment is formed in a shape extending in the vibration direction of the diaphragm 33 (axis direction or sound emission direction SD). The voice coil 31 is not limited to this shape.

The diaphragm 33 is vibratably supported by the frame 4 via the edge 34. The diaphragm 33 according to this embodiment is annularly formed, and an outer periphery portion of the diaphragm 33 is vibratably supported by the frame 4 or yoke 21 via the edge 34, and an inner periphery part of the diaphragm 33 is connected to the voice coil 31.

Further, the diaphragm 33 has the conducting part 335 formed on a part or whole of the diaphragm. According to this embodiment, the whole diaphragm 33 is formed with a conducting material. As a conducting material, for example, a conducting metal such as aluminum, copper, iron or a magnetic body having conducting property may be adopted. Specifically, the conducting part 335 of the diaphragm is annularly formed in the circumferential direction. Further, the conducting part 335 of the diaphragm 33 is formed in a face distributed shape with a prescribed width (L335) in the radial direction of the diaphragm 33.

This conducting part 335 of the diaphragm 33 is arranged preferably in proximity of the voice coil 31. This is because, the closer the voice coil 31 is to the conducting part 335, the larger driving force is generated in the conducting part 335 by electromagnetic induction in the above speaker device 1 as described later.

Further, the diaphragm 33 is arranged between the first magnetic pole part (MP1) and the second magnetic pole part (MP2), in the DC magnetic field (static magnetic field) MD1. More specially, the conducting part 335 formed at the diaphragm 33 is arranged between the first magnetic pole part (MP1) and the second magnetic pole part (MP2), and arranged in the DC magnetic field (static magnetic field) MD1.

Further, the cross-sectional shape of the conducting part 335 is formed in a shape substantially following the lines of magnetic force (MD1) passing through between the first magnetic pole part (MP1) and the second magnetic pole part (MP2) as shown in FIG. 3(A). In the magnetic circuit 2 according to this embodiment, the lines of magnetic force (MD1) of the magnetic gap are radially and substantially linearly formed, and the cross-sectional shape of the conducting part 335 in the radial direction is formed in a linear shape.

The conducting part 335 of the diaphragm 33 is arranged near the radially outside of the voice coil 31, and the conducting part 335 is annularly formed in the circumferential direction.

When driving the speaker, for example, upon an induction current flowing in the conducting part 335 arranged between the first and the second magnetic pole parts, an electromagnetic force (Lorentz force) is generated in the conducting part 335 in response to the induction current and the magnetic field (MD1) between the first and the second magnetic pole parts. This electromagnetic force has a component in parallel with the vibration direction of the diaphragm 33 based on Fleming's left-hand rule.

More specially, the conducting part 335 of the diaphragm 33 is formed in a shape such that an electromagnetic force (Lorentz force) generated in the conducting part 335 has a component parallel with the vibration direction of the diaphragm 33 when driving the speaker, specifically in a shape substantially following the lines of magnetic force between the first and the second magnetic pole parts.

With the conducting part 335 of the diaphragm 33 formed in the shape following the lines of magnetic force (MD1) of the above magnetic gap, a comparatively large electromagnetic force is generated in the conducting part 335 of the diaphragm 33 in the vibration direction of the voice coil 31 when driving the speaker in state of an induction current flowing in the conducting part 335.

Further, with the conducting part 335 of the diaphragm 33 formed in the above shape, the driving force (F1) of the voice coil 31 is easy to be transmitted to the whole diaphragm 33.

Further, with the conducting part 335 of the diaphragm 33 formed in the above shape, the whole diaphragm 33 can be vibrated substantially in the same phase.

The edge (diaphragm support part) 34 is formed between the outer periphery part of the diaphragm 33 and the frame 4. The edge 34 is connected to the end portion of the diaphragm 33 and vibratably supports the diaphragm. Further, the edge 34 is formed with an insulating material. As the insulating material, for example, resin such as polyurethane resin, rubber, unwoven fabric, etc. may be adopted. Further, the edge 34 may emit a sound wave as the diaphragm 33 does, and the diaphragm 33 may be the first vibrating part while the edge 34 may be the second vibrating part. Further, the edge 34 may be a diaphragm support part supporting the diaphragm at the frame.

Specifically, since the vibrating body 3 including the conducting part 335 is connected to non-vibrating body such as the yoke or the frame 4 via the edge 34 formed with an insulating material, the conducting part 335 is electrically insulated from the non-vibrating body.

The support member 4 (frame) vibratably supports the vibrating body 3. The support member 4 according to this embodiment, for example, is formed in a tubular shape and arranged in the inner side of the outer periphery side part 212 of the yoke 21 as shown in FIG. 2(B). The outer periphery end 332 of the edge 34 is connected to the upper end portion of the support member 4 with adhesive, etc. Further, the outer periphery side part of the diaphragm 33 may be connected to the upper end portion of the support member 4 with adhesive, etc. without the edge 34 as necessary.

The terminal part 5 is electrically connected to the voice coil 31 with a lead wire (speaker wire) 501 as shown in FIG. 2(B). Further, the terminal part 5, for example, is connected to processing equipment (not shown) such as a portable music player. This terminal part 5, for example, is arranged at an outer side part of the speaker device 1, specifically, at the side face part or the bottom face part of the yoke 21, etc. as shown in FIG. 2(B).

An operation of the above speaker device 1 is described. According to the above speaker device 1, when driving the speaker, upon a signal current inputted to the terminal part 5, the signal current is inputted to the voice coil 31 via the lead wire 501. When the signal current is inputted to the voice coil 31, a Lorentz force is generated in the voice coil 31 in response to the signal current. The voice coil 31 is vibrated in the axis direction (sound emission direction SD) of the voice coil 31by the Lorentz force as a driving force F1 (first driving force). The driving force F1 (first driving force) generated in the voice coil 31 is transmitted to the diaphragm 33 via the connecting part connecting the voice coil 31 and the diaphragm 33, and the diaphragm 33 is vibrated by the driving force F1 (first driving force).

Further, in the speaker device 1, when driving the speaker, upon a signal current (AC current) inputted in the voice coil 31, alternating magnetic field MA1 (also referred to as alternating magnetic flux or variation magnetic flux) is generated around the voice coil 31 as shown in FIG. 3(A).

An electromagnetic induction is generated in the annular conducting part 335 of the diaphragm 33 by the alternating magnetic field MA1 and an induction current (A1) is generated in the conducting part 335 as shown in FIG. 3(B), and a driving force F2 (second driving force) is generated in the conducting part 335 of the diaphragm 33 in response to the DC magnetic field and the induction current in the magnetic gap. The direction of this driving force F2 (second driving force) is substantially the same direction of the Lorentz force (first driving force F1) generated in the voice coil 31 (Fleming's left-hand rule). The diaphragm 33 is vibrated by this driving force F2 and the driving force F1.

The larger the static magnetic flux (MD1) passing through the conducting diaphragm 33 by electromagnetic induction and the induction current (A1) by electromagnetic induction are, the larger is the amplitude of vibration of the diaphragm 33, and thus high sensitivity can be realized.

The speaker device 1 according to the present invention, since the driving force (F2) is generated at the diaphragm itself by electromagnetic induction in addition to the amplitude of vibration generated by the driving force (F1) of the voice coil, a comparatively high sound pressure can be provided. In short, the speaker device 1 is a hybrid speaker provided with electrodynamic type and electromagnetic induction type.

Further, in the speaker device 1, when driving the speaker, since the diaphragm 33 is driven by the first driving force F1 and the second driving force F2, the diaphragm 33 and the voice coil 31 can vibrate substantially in the same phase, and thus a sound wave, with a comparatively high sound pressure and a high sound quality, can be emitted.

The speaker device 1 according to the present invention, with the annular diaphragm 33 formed between the first and the second magnetic pole parts as shown in FIGS. 2(A) and 2(B), is comparatively thin compared to a common electrodynamic speaker device, for example, including a dome shaped diaphragm.

Further, the speaker device 1 includes the conducting part 335 face distributed over the whole diaphragm 33 as shown in FIGS. 2(A) and 2(B). As such, the driving force (F2) is generated over the whole diaphragm 33 by the induction current (A1) and the DC magnetic field (MD1) and the diaphragm is face driven. In a common speaker, a driving force is transmitted from a voice coil to a diaphragm via the connecting part. In the speaker device according to the present invention, driving by the conducting part of the diaphragm is face driven in addition to driving by the voice coil, depression of energy is comparatively small at the diaphragm, and thus comparatively a stabilized frequency characteristic can be realized.

Further, the speaker device 1, with the diaphragm 33 itself playing a role of a conducting body to increase sound pressure, makes it possible to realize a comparatively low manufacturing cost, a comparatively small manufacturing man-hours, etc.

Further, for example, in a common electrodynamic speaker device, a half apex angle of the diaphragm is required to be small to improve the characteristic at high frequency range, and thus the total height of the speaker device becomes comparatively large.

By contrast, in the speaker device 1 according to the present invention, since the diaphragm is face driven over a wide area, the half apex angle is not required to be small, and thus it can be made thin and can increase a frequency range.

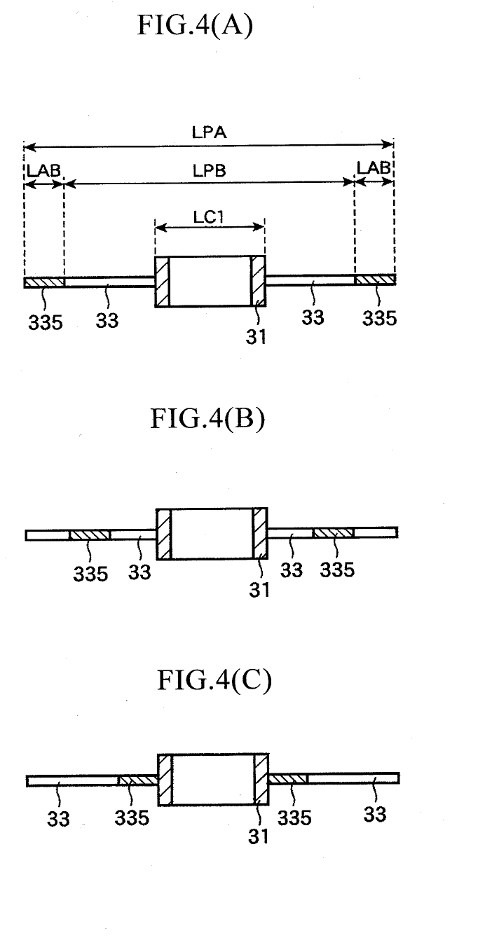

FIG. 4(A) is a cross-sectional view of an annular conducting part 335 having a large-sized outer diameter provided at the voice coil 31 and the diaphragm 33, FIG. 4(B) is a cross-sectional view of a conducting part 335 with a medium-sized outer diameter, and FIG. 4(C) is a cross-sectional view of an annular conducting part 335 with a small-sized outer diameter.

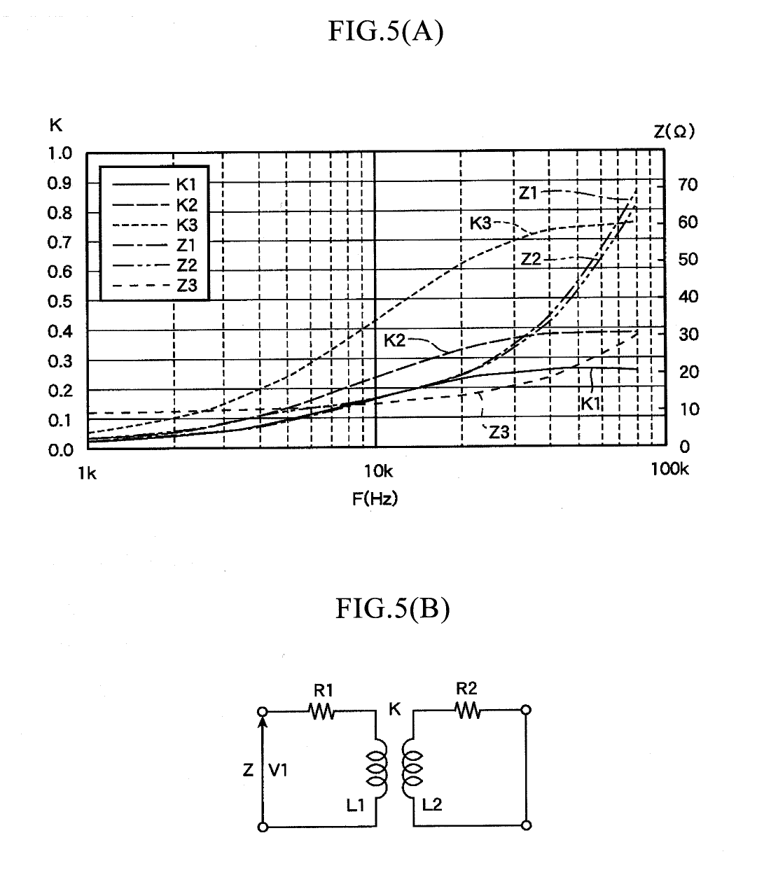

FIG. 5(A) is a view illustrating impedance of a speaker, electrical coupling coefficient between a voice coil of a speaker and a conducting part, and the respective frequency characteristics. The horizontal axis represents frequency F (unit: Hz), the right vertical axis represents input impedance Z (unit: Ω) of the speaker device 1 and left vertical axis represents electromagnetic coupling coefficient K between the voice coil 31 and the conducting part 335. FIG. 5(B) is a view of an equivalent circuit illustrating an operation of the speaker according to the present invention.

As described above, the speaker device 1 includes an electrodynamic part and an electromagnetic induction part, and the electrodynamic part and the electromagnetic induction part cooperatively work to vibrate the diaphragm.

As shown in FIG. 5(B), the induction part of the speaker device 1 is equivalent to a transformer configured with, for example, the voice coil 31 in a primary side (inductance L1 and resistance R1 are connected in series) and a conducting diaphragm 33 (conducting part 335) in a secondary coil with one coil turn (inductance L2 and resistance R2 are connected in series). The amplitude of induction current depends on the coupling coefficient K of this transformer.

An inventor of the present application prepared diaphragms 33 including annular conducting parts 335 with different outer diameters and the voice coils 31, and measured respective coupling coefficients K and input impedances Z. The annular conducting parts 335 were, for example, an annular conducting part 335 with a large-sized outer diameter shown in FIG. 4(A), an annular conducting part 335 with a medium-sized outer diameter shown in FIG. 4(B) and an annular conducting part 335 with a small-sized outer diameter shown in FIG. 4(C). As the forming material of the conducting part 335 of the diaphragm 33, oxygen-free copper C1020 was adopted.

As shown in FIG. 4(A), the outer diameter LPA of the annular conducting part 335 is about 3.0 times as large as the diameter LC1 of the voice coil 31, and the inner diameter LPB is about 2.3 times as large as the diameter LC1 of the voice coil 31. The width LAB in a radial direction is constantly about 0.34 times as large as the diameter LC1 of the voice coil 31.

FIG. 5(A) shows coupling coefficient K1 and input impedance Z1 related to the diaphragm 33 and the voice coil 31 shown in FIG. 4(A).

According to FIG. 4(B), the outer diameter LPA of the annular conducting part 335 is about 2.3 times as large as the diameter LC1 of the voice coil 31, and the inner diameter LPB is about 1.6 times as large as the diameter LC1 of the voice coil 31. The width LAB in a radial direction is constantly about 0.34 times as large as the diameter LC1 of the voice coil 31.

FIG. 5(A) shows coupling coefficient K2 and input impedance Z2 related to the diaphragm 33 and the voice coil 31 shown in FIG. 4(B).

According to FIG. 4(C), the outer diameter LPA of the annular conducting part 335 is about 1.7 times as large as the diameter LC1 of the voice coil 31, and the inner diameter LPB is about 1.0 times as large as the diameter LC1 of the voice coil 31. The width LAB in a radial direction is constantly about 0.34 times as large as the diameter LC1 of the voice coil 31.

FIG. 5(A) shows coupling coefficient K3 and input impedance Z3 related to the diaphragm 33 and the voice coil 31 shown in FIG. 4(C).

The measurement results show in FIG. 5(A) that coupling coefficient K and impedance Z (S2) are increased from low frequency (about 1 kHz) to high frequency range (about 100 kHz) in each of vibrating bodies shown in FIGS. 4(A) to 4(C).

Specifically, as shown in FIG. 5(A), the closer the conducting part 335 is to the voice coil 31, i.e. the smaller the outer diameter is, the higher value the coupling coefficient K showed. Specifically, the coupling coefficient K3 of the vibrating body, including the conducting part 335 with the small sized outer diameter shown in FIG. 4(C), showed the highest value.

Further, when the coupling coefficient K is comparatively high, since rise of input impedance Z can be restrained even at high frequency range, the speaker device can emit a sound wave with high sound pressure even at high frequency range without electrodynamic part driving force extremely decreased as shown in FIG. 5(A). Specifically, the input impedance Z3 of the vibrating body, including the conducting part 335 with the small sized outer diameter shown in FIG. 4(C), shows the lowest value.

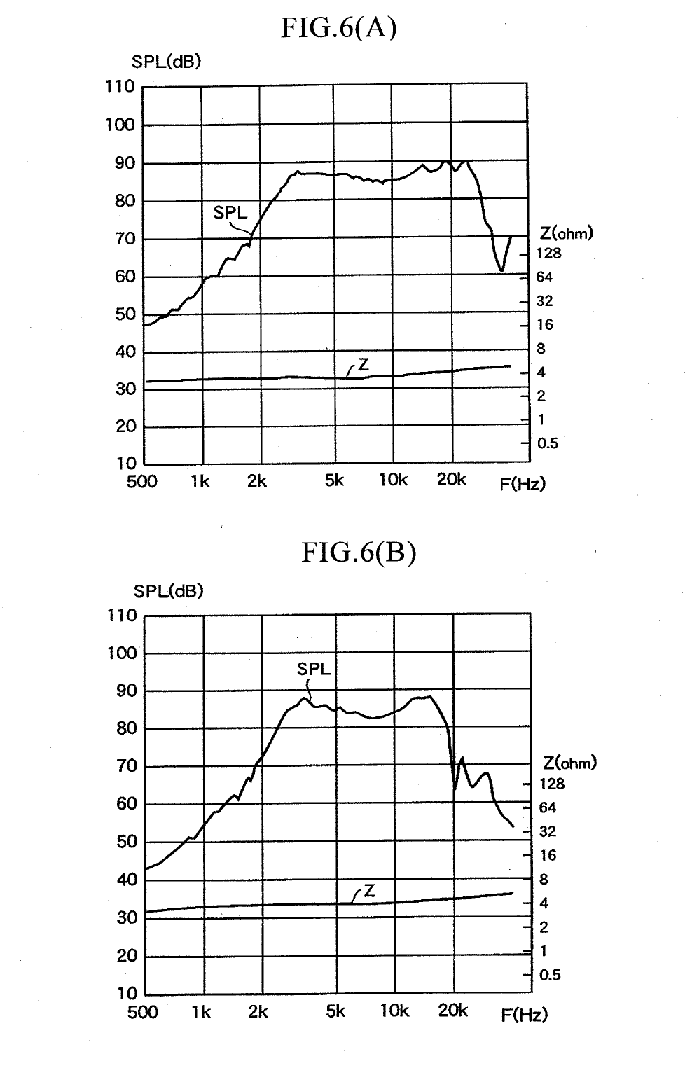

FIG. 6(A) is a view illustrating a sound pressure frequency characteristic of the speaker device 1 according to an embodiment of the present invention. FIG. 6(B) is a view illustrating a sound pressure frequency characteristic of the speaker device according to a comparative example. In FIGS. 6(A) and 6(B), the horizontal axis represents frequency F (Hz), and the left vertical axis represents sound pressure (SPL (sound pressure level): unit dB (decibel)) and the right vertical axis represents input impedance Z (unit: Ω (ohm)) of the speaker.

The inventor of the present application measured a sound pressure frequency characteristic and an input impedance Z in the cases that the material of the diaphragm of the speaker device 1 according to the present invention is a conducting body (aluminum) (FIG. 6(A)), and that the material of the diaphragm of the speaker device according to a comparative example is a nonconducting body (paper) (FIG. 6(B)) respectively.

In comparison with the sound pressure level of the sound pressure frequency characteristic of the speaker device according to the comparative example shown in FIG. 6(B), it was shown that the sound pressure level of the sound pressure frequency characteristic of the speaker device 1 according to the present invention shown in FIG. 6(A) was high.

Further, in the sound pressure frequency characteristic shown in FIG. 6(B), a dip occurs at frequency around 20 kHz while no such dip is found in the sound pressure frequency characteristic of the speaker device 1 according to the present invention shown in FIG. 6, which shows comparatively flat values. In short, in the speaker device 1 according to the present invention, the diaphragm 33 is vibrated with a drive by a driving force F1 and a face drive (driving force F2) in the conducting part 335 of the diaphragm 33, the frequency characteristic becomes flat and high sound quality is achieved.

### Second Embodiment

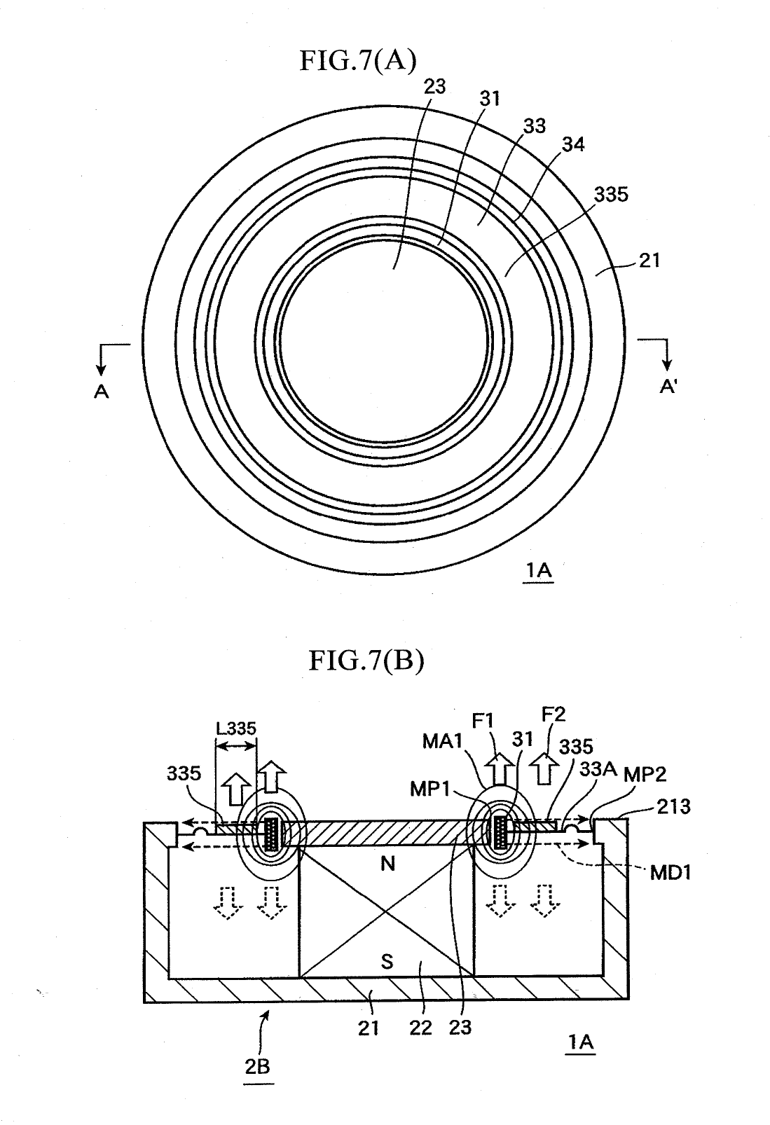

FIG. 7(A) is a front view of the speaker device according to a second embodiment of the present invention. FIG. 7(B) is a cross-sectional view taken along line A-A′ of the speaker device 1 shown in FIG. 7(A). Descriptions for the same configurations as the first embodiment are omitted.

The speaker device 1a according to this embodiment includes a diaphragm 33A formed with a non-conducting material and the conducting part 335 formed with a conducting material formed on both or either one of the front and rear faces of the diaphragm 33A.

Specifically, as the forming material of the diaphragm 33A, for example, a non-conducting material such as paper, polyimide, resin film such as polyetherimide, etc. can be adopted.

The conducting part 335 is annularly formed on both or either one of the front and rear surfaces of the diaphragm 33A in the circumferential direction as shown in FIGS. 7(A) and 7(B). Further, the conducting part 335 of the diaphragm 33A is formed in a face distributed shape with a prescribed width (L335) along the radial direction of the diaphragm 33A. As a forming material of this conducting part 335, for example, a conducting metal such as aluminum or copper, or a conducting magnetic body may be adopted.

The speaker device 1A of this embodiment includes, for example, the diaphragm 33A formed with a non-conducting body such as a paper, an unwoven fabric constructed with fibers, a sheet of resin-having an unwoven fabric, resin such as polyimide (thermosetting resin and thermoplastic resin are included) etc. and the conducting part 335 formed with the conducting body such as aluminum evaporated in the front face side of the diaphragm 33A.

In comparison with the first embodiment, in the above speaker device 1A the diaphragm 33 and the conducting part 335 can be formed with desired forming materials by combining a non-conducting body and a conducting body, and thus a desired sound pressure frequency characteristic can be achieved.

Further, by adopting the conducting part 335 that has a broadly or narrowly prescribed width in a radial direction, the speaker device 1A can achieve a desired acoustic characteristic.

### Third Embodiment

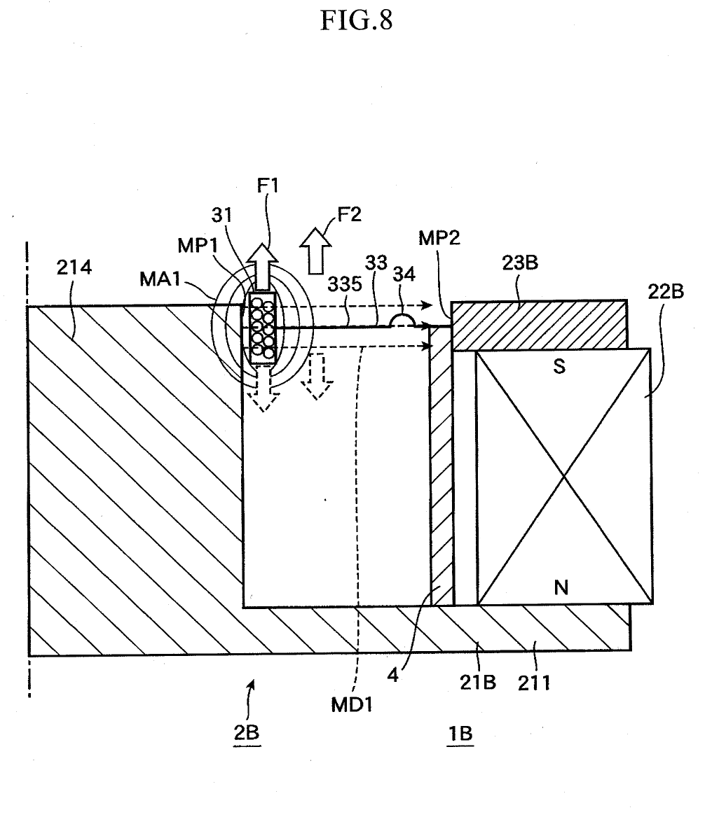

FIG. 8 is a cross-sectional view of the speaker device 1B according to a third embodiment of the present invention. Descriptions for the same configurations as the first embodiment and the second embodiment are omitted. The half left part of the axis symmetrically-formed speaker device 1B is omitted in FIG. 8.

As shown in FIG. 8, the speaker device 1B according to this embodiment is an outer-magnetic type magnetic circuit. Specifically, the speaker device 1B includes a magnetic circuit 2B, vibrating body 3 and support member (frame) 4. The magnetic circuit 2B includes a yoke 21B, a magnet 22B and a plate 23B. The yoke 21B includes a tabular bottom face part 211 and pole part 214 formed at the central part. The bottom face part 211 and the pole part 214 are integrally formed.

The magnet 22B is annularly formed and arranged on the bottom face part 211 of the yoke 21B.

The plate 23B is annularly formed with a magnetic body and arranged on the magnet 22B. The inner diameter of the plate 23B is formed smaller than the inner diameter of the magnet 22B. In the magnetic circuit 2B a magnetic gap is formed between the plate 23B and the pole part 214 of the yoke 21B. The pole part 214 of the yoke 21B corresponds to an embodiment of the first magnetic pole part MP1 and the plate 23B corresponds to an embodiment of the second magnetic pole part MP2. The DC magnetic field (static magnetic field) MD1 is formed between the first magnetic pole part MP1 and the second magnetic pole part MP2. The voice coil 31 and the diaphragm 33 are arranged in the magnetic gap formed between the first magnetic pole part MP1 and the second magnetic pole part MP2. The conducting part 335 is formed at the diaphragm 33 as in the first embodiment or the second embodiment.

The support member 4 is annularly formed and arranged on the bottom face part 211 of the yoke 21. Further, the support member 4 has the upper end portion with a prescribed height reaching near the height of the plate 23B, and the diaphragm 33 is supported by the upper end portion via the edge 34. Further, the outer periphery side part of the diaphragm 33 may be connected to the upper end portion of the support member 4 with adhesive, etc. without providing the edge 34, as necessary.

The above speaker device 1B includes the outer-magnetic type magnetic circuit 2B, and when driving the speaker, upon a signal current inputted in voice coil 31 arranged between the first magnetic pole part MP1 and the second magnetic pole part MP2, a driving force F1 is generated in the voice coil 31 and a driving force F2 is generated by electromagnetic induction in the conducting part 335 formed near the voice coil 31, the conducting part 335 is formed between the first magnetic pole part MP1 and the second magnetic pole part MP2.

In short, the speaker device 1B, including the outer-magnetic type magnetic circuit 2B, can have the diaphragm and the voice coil vibrate substantially in the same phase, and thus can emit a sound wave with a high sound quality by a comparatively high sound pressure.

### Forth Embodiment

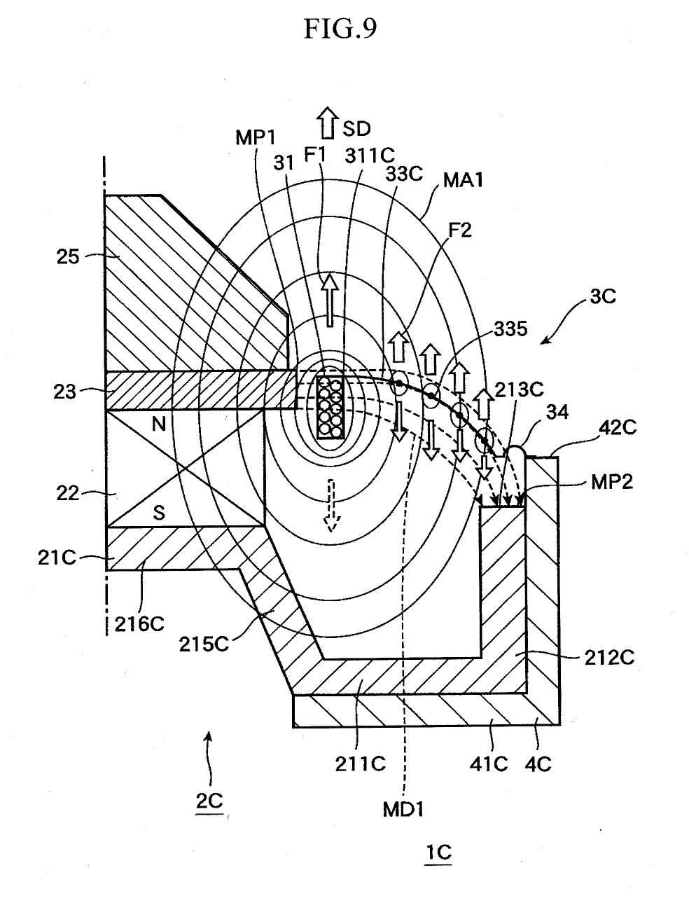

FIG. 9 is a cross-sectional view of the speaker device 1C according to a fourth embodiment of the present invention. Descriptions for the same configurations as the first embodiment to the third embodiment are omitted. The half left part of the axis symmetrically-formed speaker device 1C is omitted in FIG. 9.

The speaker device 1C includes a magnetic circuit 2C, vibrating body 3C and support member (frame) 4C as shown in FIG. 9.

The magnetic circuit 2C is an inner-magnetic type magnetic circuit and specifically includes a yoke 21C, magnet 22, a plate (pole piece) 23 and a center plug 25.

The yoke 21C includes a bottom face part 211C, an outer periphery side part 212C (tubular part), a slant part 215 and a flat part 216. Specifically, the yoke 21C includes the flat part 216 at the central part. The flat part 216 is formed to be raised from the bottom face part 211C in the sound emission direction. The flat part 216 connects to the bottom face part 211C via the slant face part 215C. The tubular outer periphery side part 212C is formed at the outer periphery portion of the bottom face part 211C and the upper end portion of the outer periphery side part 212C is formed at a position lower than the height of the plate 23. Further, the outer periphery side part 212C is larger in the diameter than the plate 23. The above bottom face part 211C, the outer periphery side part 212C, the slant face 215 and the flat part 216 are integrally formed. Also, the above bottom face part 211C, the outer periphery side part 212C, the slant face 215 and the flat part 216 may be formed with different members as necessary.

The magnet 22 is arranged on the flat part 216C of the yoke 21. Further, the magnet 22 according to this embodiment is formed in a columnar shape, and magnetized in the axis direction (thickness direction).

The plate (pole piece) 23 is formed on the magnet 22 and arranged at a position higher than the upper end portion of the outer periphery side part 212C of the yoke 21C.

The center plug 25 is formed, for example, with resin or metal material, etc. The center plug 25 is arranged on the plate 23. The center plug 25 is formed in a shape projecting in the axis direction (the sound emission direction SD). A shape and a material of the center plug 25 are prescribed, so that a frequency characteristic and a phase by a sound wave emitted from the speaker device are a desired frequency characteristic and a phase. The center plug 25 may be arranged as an equalizer.

The plate 23 corresponds to an embodiment of the first magnetic pole part MP1 and the yoke 21C corresponds to an embodiment of the second magnetic pole part MP2. Specifically, the second magnetic pole part MP2 is formed on the upper end portion of the outer periphery side part (tubular part) 212C.

As shown in FIG. 9, the speaker device 1C is configured such that the second magnetic pole part MP2 is positioned radially outside of the first magnetic pole part MP1, spaced apart by a prescribed distance therefrom, and formed at a position lower than the first magnetic pole part MP1 (a position spaced apart by a prescribed distance in the opposite direction of the sound emission direction SD). As such, a line or lines of magnetic force (DC magnetic field) MD1 are formed in a curved shape toward the sound emission direction SD between the first magnetic pole part MP1 and the second magnetic pole part MP2.

The vibrating body 3C includes the voice coil 31, the diaphragm 33C and the edge 34.

The voice coil 31 is connected to the inner periphery part of the diaphragm 33C, and is vibratably arranged near the plate 23. The voice coil 31 according to this embodiment has its upper end portion 311C joined to the inner periphery part of the diaphragm 33C.

The diaphragm 33C has a cross-sectional shape in a radial direction formed in a shape (curved shape) substantially following the line of magnetic force passing through between the first magnetic pole part MP1 and the second magnetic pole part MP2. Further, the diaphragm 33C includes the conducting part 335. According to this embodiment the diaphragm 33C itself is formed with a conducting material, such as aluminum or copper, the diaphragm 33C itself corresponds to the conducting part 335.

The edge 34 is annularly formed and arranged between the diaphragm 33C and the frame 4C. Specifically, the edge 34 has an inner periphery part and an outer periphery part. The inner periphery part of the edge 34 is connected to the outer periphery part of the diaphragm 33C and the outer periphery part of the edge 34 is connected to the upper end portion of the frame 4C, and thereby supports the diaphragm 33C.

The support member (frame) 4C is annularly formed having a larger outer diameter than outer diameters of the first magnetic pole part MP1 and the second magnetic pole part MP2. Specifically, the support member 4C includes an annular flat part 41C arranged on the downside of the bottom face part 211C of the yoke 21C and a tubular part 42C extending in the sound emission direction from the periphery portion of the flat part 41C. The tubular part 42C has its upper end portion formed in a position higher than the upper end portion of the yoke 21C. The flat part 41C and the tubular part 42C of the support member 4C are integrally formed with a material, for example, such as resin. The flat part 41C of the support member 4C and the tubular part 42C may be formed with different members as necessary. The diaphragm 33C of the vibrating body 3C is extended to the frame 4 beyond the second magnetic pole part MP2 of the yoke 21C.

The operation of the above speaker device 1C is described.

According to the above speaker device 1C, upon a signal current inputted to the voice coil 31, a Lorentz force is generated in the voice coil 31 in response to the signal current. The voice coil 31 vibrates in the axis direction (sound emission direction SD) of the voice coil 31 by the Lorentz force as a driving force F1 (first driving force). The driving force F1 (first driving force) generated at the voice coil 31 is transmitted to the diaphragm 33 via the connecting part connecting the voice coil 31 and the diaphragm 33 and the diaphragm 33 vibrates in response to the driving force F1 (first driving force).

Further, as shown in FIG. 9, in the speaker device 1C, when driving the speaker, upon a signal current (AC current) inputted to the voice coil 31, an alternating magnetic field MA1 is generated around the voice coil 31.

An electromagnetic induction is generated at the annular conducting part 335 of the diaphragm 33 due to the alternating magnetic field MA1, and an induction current is generated at the conducting part 335 as shown in FIG. 9, and thus a driving force F2 (second driving force) is generated at the conducting part 335 of the diaphragm 33 in response to the DC magnetic field and the induction current in the magnetic gap. This driving force F2 (second driving force) is directed substantially in the same direction as the Lorentz force (first driving force F1) generated at the voice coil 31.

The conducting part 335 is formed in a curved shape as shown in FIG. 9, and face distributed in the radial direction of the diaphragm 33 with a prescribed width. In the conducting part 335, the driving force F2 is generated by electromagnetic induction at the respective positions within a face of the diaphragm. This driving force F2 has a component parallel with the sound emission direction. The phase of the driving force F2 is substantially the same phase as the driving force F1.

The diaphragm 33C including this conducting part 335 moves substantially in the same phase as the driving force F1 generated at the voice coil 31.

The above speaker device 1C, since the diaphragm 33C has the cross-sectional shape in the radial direction formed in a curved shape compared to the first and the second embodiments, can emit a sound wave by a comparatively high sound pressure in a comparatively large angle direction (for example from around 0° to) 90°) with reference to the sound emission direction SD. Further, the speaker device 1C, since the diaphragm 33C is driven by the driving force F1 and the driving force F2 substantially in the same phase as in the first embodiment, can emit a sound wave with a high sound quality by a comparatively high sound pressure.

Further, the above speaker device 1C, provided with the center plug 25, can emit a sound wave with a desired frequency characteristic.

### Fifth Embodiment

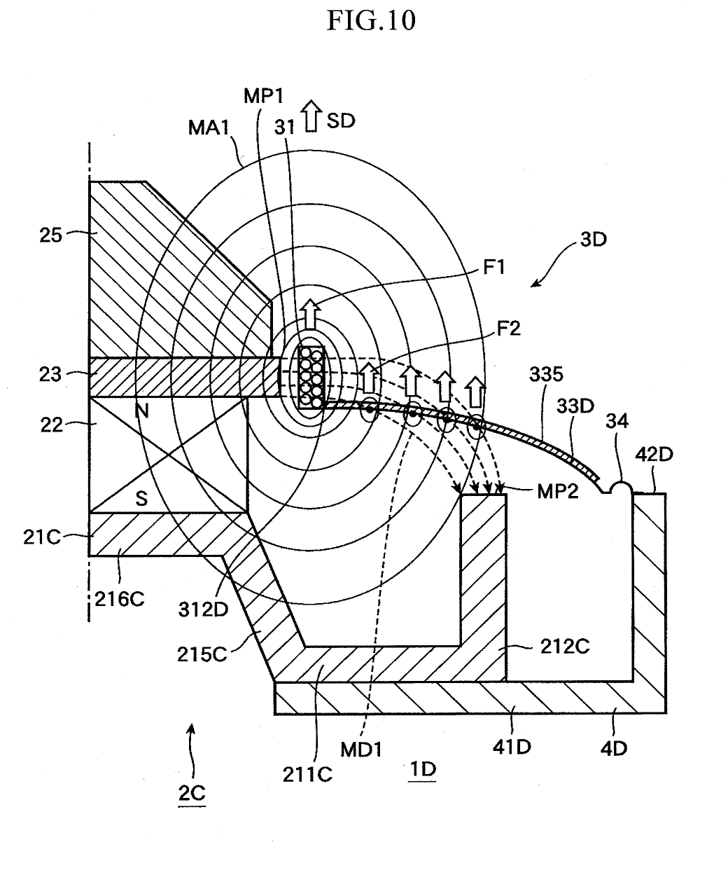

FIG. 10 is a cross-sectional view of the speaker device 1D according to a fifth embodiment of the present invention. Descriptions for the same configurations as the first embodiment to the forth embodiment are omitted. The half left part of the axisymmetrically-formed speaker device 1D is omitted in FIG. 10.

The speaker device 1D includes a magnetic circuit 2C, a vibrating body 3D and a support member (frame) 4D as shown in FIG. 10.

The vibrating body 3D includes a voice coil 31, a diaphragm 33D and an edge 34. The diaphragm 33D has the end portion of inner periphery part connected to a lower end portion 312D of the voice coil 31.

Further the speaker device 1D includes a diaphragm 33D formed with a non-conducting material and a conducting part 335 formed with a conducting material at both or either one of the front and the rear faces of the diaphragm 33D. Specifically, as the forming material of the diaphragm 33D, for example, non-conducting material such as paper, polyimide, resin film such as polyetherimide may be adopted. The conducting part 335 is formed by evaporating a conducting metal such as aluminum, copper, etc.

The support member (frame) 4D is annularly formed with the outer diameter larger than the outer diameter of the magnetic pole part MP1 and the second magnetic pole part MP2.

Specifically, the support member 4D includes an annular flat part 41D arranged on the downside of the yoke 211C and a tubular part 42D extending in the sound emission direction from the outer periphery part of the flat part 41D. The tubular part 42D has an upper end portion formed substantially at the same height as the upper end portion of the yoke 21C. The tubular part 42D may have the upper end portion formed so that the upper end portion of the tubular part 42D is lower or higher than the upper end portion of the yoke 21C. Although the flat part 41D and the tubular part 42D of the support member 4D are integrally formed with, for example, a material such as resin, the flat part 41D and the tubular part 42D of the support member 4D may be formed with different members as necessary.

Further, the tubular part 42D of the frame 4D is formed large in the diameter compared to the tubular part 42C of the frame 4C of the fourth embodiment. The diaphragm 33 of the vibrating body 3C is extended to the frame 4 beyond the second magnetic pole part MP2 of the yoke 21C.

In comparison with the fourth embodiment, the above speaker device 1D can have the diaphragm 33D and the conducting part 335 formed with desired forming materials by combining a nonconducting body and a conducting body, and thus a desired sound pressure frequency characteristic can be achieved. Further, by adopting the conducting part 335 that has a broadly or narrowly prescribed width in a radial direction, the speaker device 1A can achieve a desired acoustic characteristic.

Further, since the upper end portion of the yoke 21C is arranged near the central part of the diaphragm 33D and the conducting part 335 in a radial direction, the speaker device 1D has the comparatively large driving force F2 compared to the fourth embodiment. As such, the speaker device 1D can emit a sound wave with a high sound quality by a comparatively high sound pressure.

### Sixth Embodiment

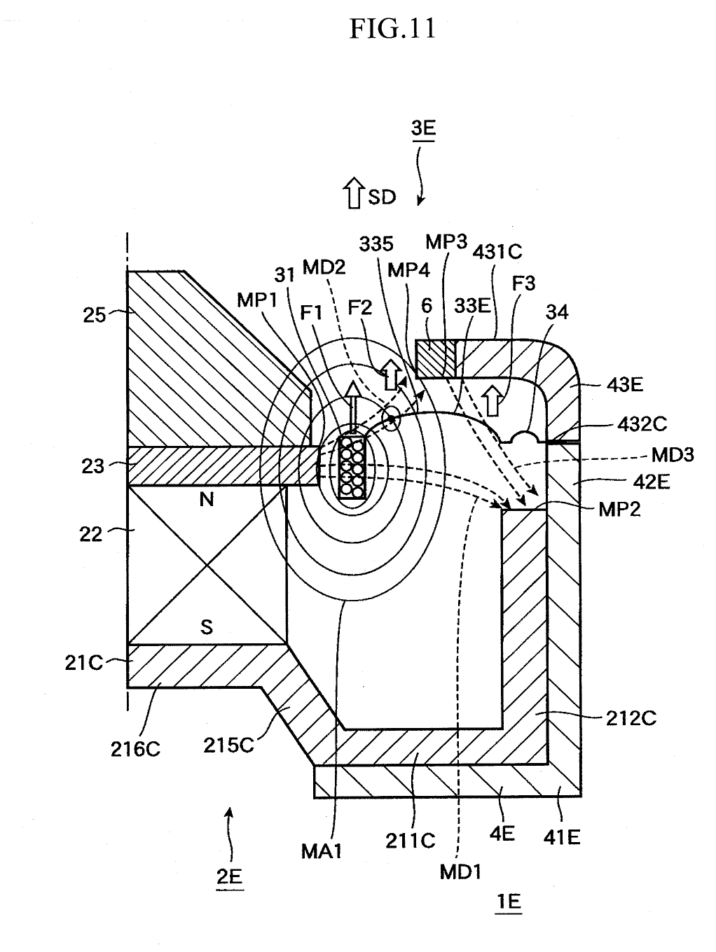

FIG. 11 is a cross-sectional view of the speaker device 1E according to a sixth embodiment of the present invention. Descriptions for the same configurations as the first embodiment to the fifth embodiment are omitted. The half left part of the axisymmetrically-formed speaker device 1E is omitted in FIG. 11.

As shown in FIG. 11, the speaker device 1E includes a magnetic circuit 2E, a vibrating body 3E and a support member (frame) 4E.

The magnetic circuit 2E includes a yoke 21C, magnet 22, a plate 23, a center plug 25 and a magnetic body 6.

The magnetic body 6 is arranged above the vibrating body 3E. Specifically, magnetic body 6 is arranged, for example, substantially at the middle part between the plate 23 and the outer periphery side part 212C of the yoke 21C in a radial direction and at a position higher than the plate 23 (on the side of sound emission direction SD). Further, although the magnetic body 6 is arranged in the direction (horizontal direction) that the plate 23 extends, it may be arranged projecting toward the support member 4E or in the sound emission direction. The magnetic body 6 may be a magnet or a ferromagnetic body such as iron. The magnetic body 6 is arranged near the magnet 22 and magnetized by a surrounding magnetic field.

The plate 23 corresponds to an embodiment of the first magnetic pole part (MP1). The upper end portion of the yoke 21C corresponds to an embodiment of the second magnetic pole part (MP2).

The magnetic body 6 has a third magnetic pole part (MP3) and a fourth magnetic pole part (MP4), for example by magnetization.

A magnetic gap is formed between the first magnetic pole part (MP1) and the second magnetic pole part (MP2), and a curved line or curved lines of magnetic force (DC magnetic field) MD1 are formed in the magnetic gap. A magnetic gap is formed between the magnetic body 6 and the first magnetic pole part (MP1). Specifically, a curved line or curved lines of magnetic force (DC magnetic field) MD2 are formed between the fourth magnetic pole part (MP4) of the magnetic body 6 and the first magnetic pole part (MP1).

A magnetic gap is formed between the magnetic body 6 and the second magnetic pole part (MP2). Specifically, a curved line or curved lines of magnetic force (DC magnetic field) MD3 are formed between the third magnetic pole part (MP3) of the magnetic body 6 and the second magnetic pole part (MP2).

The vibrating body 3E includes a voice coil 31, a diaphragm 33E and an edge 34. The diaphragm 33E is annularly formed, the inner periphery part of the diaphragm is connected to the voice coil 31 and the outer periphery part of the diaphragm is connected to the frame 4E via the edge 34.

In the diaphragm 33E according to this embodiment, the vibrating part, between the inner periphery part and the outer periphery part, has its radially cross-sectional shape formed in a convex shape in the sound emission direction SD, and the conducting part 335 is formed at the vibrating part. This diaphragm 33E is formed substantially following the curved line of magnetic force (DC magnetic field) MD2 formed between the magnetic body 6 and the first magnetic pole part (MP1). Further, the diaphragm 33E is formed substantially following the curved line of magnetic force (DC magnetic field) MD3 formed between the magnetic body 6 and the second magnetic pole part (MP2).

In short, the conducting part 335 of the diaphragm 33E is arranged between the magnetic body 6 and the first magnetic pole part (MP1) and between the magnetic body 6 and the second magnetic pole part (MP2). Specifically, the conducting part 335 is arranged within the lines of magnetic force (DC magnetic field) MD2 and within the lines of magnetic force (DC magnetic field) MD3.

The support member 4E includes an annular flat part 41E and a tubular part 42E and a magnetic body support part 43E. The flat part 41E is arranged under the yoke 211C, the tubular part 42E extends in the sound emission direction from the outer periphery part of the flat part 41E and a magnetic body support part 43E arranged on the tubular part 32E. The flat part 41E and the tubular part 42E are integrally formed.

The magnetic body support part 43E supports the magnetic body 6 at the above position. The magnetic body support part 43 according to this embodiment is formed in an arm shape, and a lower end of the magnetic body support part is connected to the upper end portion of the tubular part 32E while its upper end portion is formed in a shape bending inward in a radial direction, and the magnetic body 6 is connected to the inner periphery part of the magnetic body support part.

An operation of the above speaker device 1E is described.

According to the above speaker device 1E, upon a signal current inputted to the voice coil 31, a Lorentz force is generated in the voice coil 31 in response to the signal current. The voice coil 31 is vibrated in the axis direction (sound emission direction SD) of the voice coil 31 by the Lorentz force as a driving force F1 (first driving force). The driving force F1 (first driving force) generated in the voice coil 31 is transmitted to the diaphragm 33E via the connecting part connecting the voice coil 31 and the diaphragm 33E and the diaphragm 33E is vibrated in response to the driving force F1 (first driving force).

Further, as shown in FIG. 11, in the speaker device 1E, when driving the speaker, upon a signal current (AC current) inputted to the voice coil 31, an alternating magnetic field MA1 (alternating magnetic flux) is generated around the voice coil 31.

An electromagnetic induction is generated at the annular conducting part 335 of the diaphragm 33 due to the alternating magnetic field MA1, and an induction current is generated at the conducting part 335 as shown in FIG. 11, and thus a driving force F2 (second driving force)in response to the DC magnetic field MD2 and the induction current in the magnetic gap and a driving force F3 (third driving force)in response to the DC magnetic field MD3 and the induction current in the magnetic gap, are generated at the conducting part 335 of the diaphragm 33.

This driving force F2 and F3 are directed substantially in the same direction as the Lorentz force (first driving force F1) generated at the voice coil 31.

Since the diaphragm 33E is acted on the driving force F1, the driving force F2 due to electromagnetic induction and the driving force F3 substantially in the same phase, the above speaker device 1E can emit a sound wave by a high sound pressure, for example, compared to the fourth embodiment.

### Seventh Embodiment

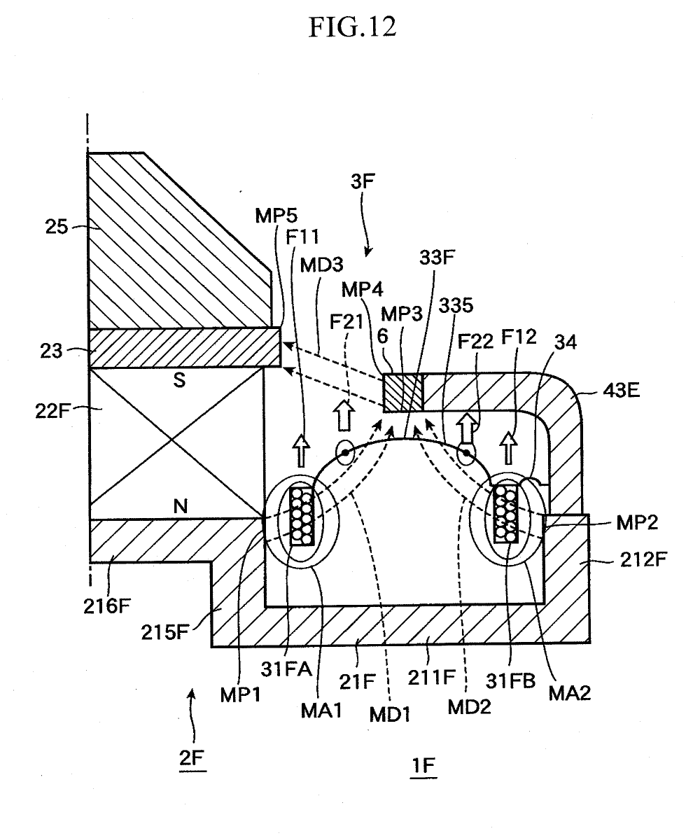

FIG. 12 is a cross-sectional view of the speaker device 1F according to a seventh embodiment of the present invention. Descriptions for the same configurations as the first embodiment to the sixth embodiment are omitted. The half left part of the axisymmetrically-formed speaker device 1F is omitted in FIG. 11.

As shown in FIG. 12, the speaker device 1F includes a magnetic circuit 2F, a vibrating body 3F and a support member (frame) 43E.

The magnetic circuit 2F includes a yoke 21F, a magnet 22F, a plate 23, a center plug 25 and a magnetic body 6.

The yoke 21F includes a bottom face part 211F, an outer periphery side part 212F (tubular part) a step part 215F, and a flat part 216F. Specifically, the yoke 21F includes at the central part the flat part 216F raised in the sound emission direction from the bottom face part 211F and the flat part 216F is connected the bottom face part 211F via the step part 215F. The tubular outer periphery side part 212F is formed at the outer periphery part of the bottom face part 211F and the upper end portion of the outer periphery side part 212F is formed at a position lower than the height of the plate 23. Further, the outer periphery side part 212F is larger in the diameter than the plate 23.

Although the above bottom face part 211F, the outer periphery side part 212F, the step part 215F and the flat part 216F are integrally formed, they may be formed with different members as necessary.

The outer periphery end portion of the flat part 216F of the yoke 21F corresponds to an embodiment of the first magnetic pole part MP1, and the upper end portion of the outer periphery side part 212F of the yoke 21F corresponds to an embodiment of the second magnetic pole part MP2. The magnetic body 6 is magnetized in the static magnetic field, and corresponds to an embodiment of the third magnetic pole part MP3 and the fourth magnetic pole part MP4. Further, the plate 23 corresponds to an embodiment of the fifth magnetic pole part MP5.

A magnetic gap is formed between the magnetic body 6 and the first magnetic pole part (MP1) and a curved line or curved lines of magnetic force (DC magnetic field) MD1 are formed in the magnetic gap. A magnetic gap is formed between the magnetic body 6 and the second magnetic pole part (MP2) and a curved line or curved lines of magnetic force (DC magnetic field) MD2 are formed in the magnetic gap. A magnetic gap is formed between the magnetic body 6 and the fifth magnetic pole part MP5 of the plate 23 and lines of magnetic force (DC magnetic field) MD3 are formed in the magnetic gap.

The vibrating body 3F includes a first voice coil 31FA, a second voice coil 31FB, a diaphragm 33F and an edge 34. The second voice coil 31FB is formed larger in the diameter than the first voice coil 31FA.

An annular diaphragm 33F is formed between the first voice coil 31FA and the second voice coil 31FB. The diaphragm 33F has a central part formed in a convex cross-sectional shape in the sound emission direction. The diaphragm 33F includes a conducting part 335.

The diaphragm 33F is formed substantially following a curved line of magnetic force (DC magnetic field) MD1 formed between the magnetic body 6 (third magnetic pole part MP3) and the first magnetic pole part (MP1). Further, the diaphragm 33F is formed substantially following a curved line of magnetic force (DC magnetic field) MD2 formed between the magnetic body 6 (third magnetic pole part MP3) and the first magnetic pole part (MP2).

For example, the second voice coil 31FB is wound in the similar direction as the first voice coil 31. Further, the similar signal current (similar phase) is inputted to the second voice coil 31FB as the signal current inputted to the first voice coil 31. The second voice coil 31FB is not limited to the above embodiment, the second voice coil may be formed so that the direction of the inputted signal current is similar to the direction of the signal current inputted to the first voice coil 31.

An operation of the above speaker device 1F is described. According to the above speaker device 1F, upon a signal current inputted to the first voice coil 31FA, a Lorentz force (driving force F11) is generated at the first voice coil 31FA in response to the signal current, while upon a signal current inputted to the second voice coil 31FB, a Lorentz force (driving force F12) is generated at the second voice coil 31FB in response to the signal current. Each of the voice coils 31FA, 31B is vibrated in the axis direction (sound emission direction SD) by the driving forces F11 and F12. The driving forces F11 and F12 generated at the voice coils 31FA and 31FB are transmitted to the diaphragm 33F via a connecting part connecting with the diaphragm 33F and the diaphragm 33F is vibrated in response to the driving forces F11 and F12.

Further, as shown in FIG. 12, in the speaker device 1F, when driving the speaker, upon a signal current (AC current) inputted to the first voice coil 31FA, an alternating magnetic field MA1 (alternating magnetic flux) is generated around the first voice coil 31FA.

An electromagnetic induction is generated in the annular conducting part 335 of the diaphragm 33F due to the alternating magnetic field MA1, and an induction current is generated at the conducting part 335, and thus a driving force F21 is generated in response to the DC magnetic field MD1 and the induction current in the magnetic gap.

As shown in FIG. 12, in the speaker device 1F, when driving the speaker, upon a signal current (current) inputted to the second voice coil 31FB, an alternating magnetic field MA2 (alternating magnetic flux) is generated around the second voice coil 31FB.

An electromagnetic induction is generated at the annular conducting part 335 of the diaphragm 33F due to the alternating magnetic field MA2, and an induction current is generated at the conducting part 335, and thus a driving force F22 is generated in response to the DC magnetic field MD2 and the induction current in the magnetic gap.

These driving forces F21 and F22 are directed substantially in the same directions as the Lorentz force (driving force F11) generated in the first voice coil 31FA and the Lorentz force (driving force F12) generated in the second voice coil 31FB.

Since the diaphragm 33F is acted on the driving force F11, F12 and the driving force F21, F22 due to electromagnetic induction substantially in the same phase, the above speaker device 1F can emit a sound wave with a high sound quality by a high sound pressure.

Although the speaker device 1F includes two voice coils 31FA, 31FB, it is not limited to this embodiment, and, for example, only the second voice coil 31B may be used.

### Eighth Embodiment

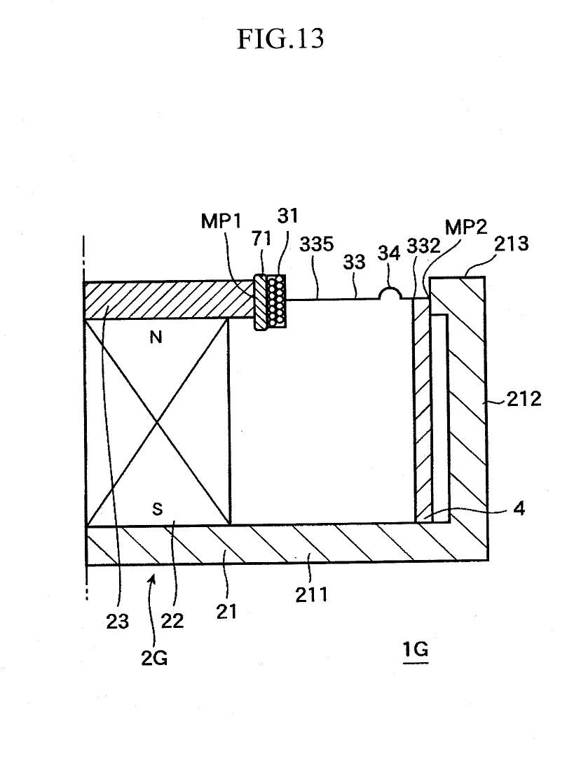

FIG. 13 is a cross-sectional view of the speaker device 1G according to an eighth embodiment of the present invention. Descriptions for the same configurations as the first embodiment are omitted. The half left part of the axisymmetrically-formed speaker device 1G is omitted in FIG. 13.

The speaker device 1G includes a magnetic circuit 2G. The magnetic circuit 2G includes a magnetic fluid 71 arranged between the voice coil 31 and the magnetic pole part (plate 23 (first magnetic pole part MP1)) arranged inside of the voice coil 31.

The speaker device 1G having the above magnetic fluid 71, heat of the voice coil 31 (Joule heat) is transmitted to the plate 23 via magnetic fluid 71, and thus heat of the voice coil 31 can be dissipated from the plate 23 as heat of radiation.

Further, the magnetic fluid 71 has viscosity. According to the speaker device 1G including the magnetic fluid 71 arranged between the plate 23 and the voice coil 31, when driving the speaker, a damping force due to the magnetic fluid 71 is applied to the voice coil 31, and thus generation of excessive amplitude of vibration can be restrained.

Further, according to the speaker device 1G including the magnetic fluid 71 between the plate 23 and the voice coil 31, contact of the voice coil 31 to the plate or the yoke can be restrained even when an excessive amplitude of vibration is generated at the voice coil 31 when driving the speaker, and thus, for example, abnormal noise generated by contact of the voice coil 31 to the plate 23 can be restrained.

### Ninth Embodiment

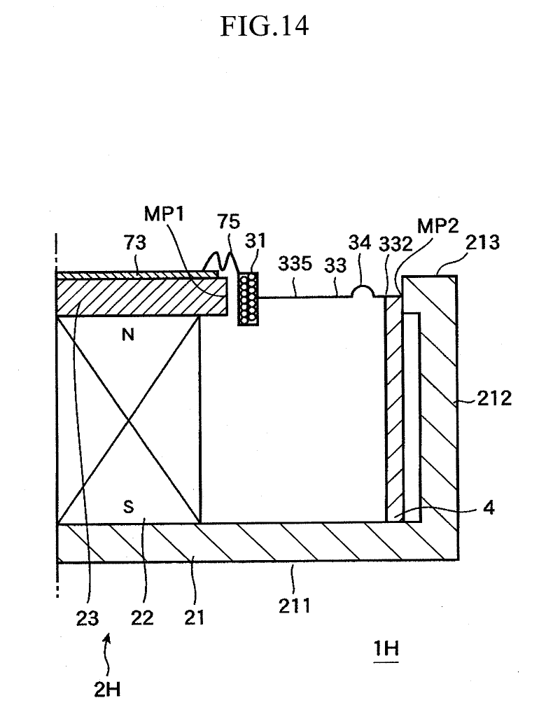

FIG. 14 is a cross-sectional view of the speaker device 1H according to a ninth embodiment of the present invention. Descriptions for the same configurations as the first embodiment are omitted. The half left part of the axisymmetrically-formed speaker device 1H is omitted in FIG. 14.

As shown in FIG. 14, the speaker device 1H includes a damper 75 and a spacer 73. The damper 75 is annularly formed, having a radially cross-sectional shape, such as a corrugated shape, convex shape, concave shape, etc. for example as shown in fig.14. The damper 75 has an outer periphery part connected to the voice coil 31 and an inner periphery part connected to the plate 23 of the magnetic circuit 2H. In this embodiment, the inner periphery part of the damper 75 is connected to the plate 23 via the spacer 73.

The diaphragm 33 has the outer periphery part supported by the frame 4 via the edge 34. Further, the inner periphery part of the diaphragm 33 is supported via a damper 75 by a magnetic pole part MP1 arranged in the inner periphery part of the voice coil 31

The spacer 73 is formed in a tabular shape and arranged on the plate 23, for example, as shown in FIG. 14.

Further, the spacer 73 is connected with the inner periphery part of the damper 75 in the proximity of the outer periphery part of the spacer 73. In short, the spacer 73 is provided to arrange the damper 75 on the plate 23, or to adjust a connecting position (height) where the damper 75 and the voice coil 31 connects and a position (height) where the damper 75 and the plate 23 connects.

The above speaker device 1H includes the above damper 75. Since the damper 75 supports the vibrating body 3, when driving the speaker, the vibrating body 3 can be stably supported.

In addition, since the speaker device 1H includes a spacer 73 with a desired thickness, the damper 75 can be easily arranged on the plate 23.

### Tenth Embodiment

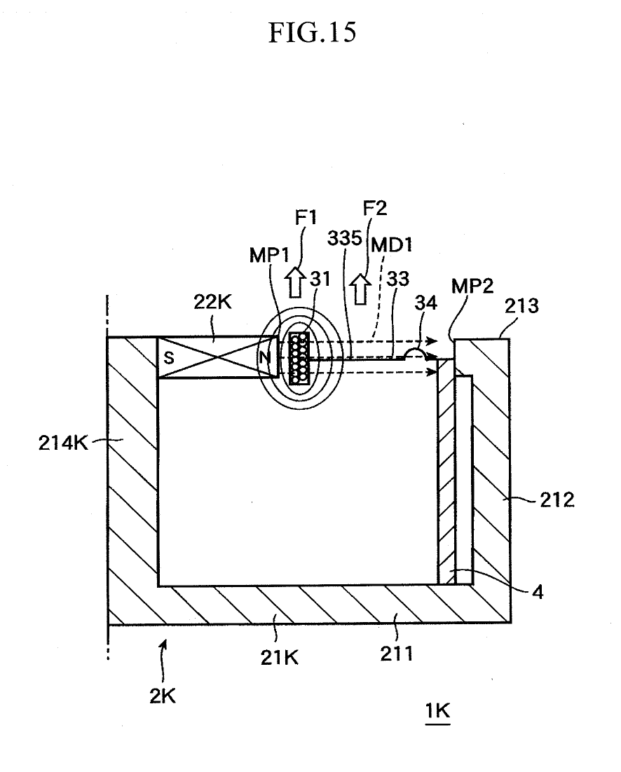

FIG. 15 is a cross-sectional view of the speaker device 1K according to a tenth embodiment of the present invention. Descriptions for the same configurations as the first embodiment are omitted. The half left part of the axisymmetrically-formed speaker device 1B is omitted in FIG. 15.

In the speaker device, a magnetic body forming a first magnetic pole part or a second magnetic pole part may be provided with a magnet magnetized in a direction orthogonal to the thickness direction.

Specifically, for example as shown in FIG. 15, the speaker device 1K includes a magnetic circuit 2K.

The magnetic circuit 2K includes a yoke 21K and a magnet 22K.

The yoke 21K includes a bottom face part 211, an outer periphery side part 212 (tubular part), an upper end portion 213 and a pole part 214K.

The pole part 214K is formed in a pole shape in the axis direction at the central part of the yoke 21K. A through hole extending in the vibration direction of the diaphragm may be formed at the pole part 214 as necessary.

The magnet 22K is formed, for example, in an annular shape. And the inner periphery part of the magnet 22K is connected to the outer periphery part of the pole part 214. Further, the magnet 22K is magnetized in a direction orthogonal to the thickness direction (axis direction). This magnet 22K corresponds to an embodiment of the first magnetic pole part MP1.

In the speaker device 1K, since a magnet 22K magnetized in a direction orthogonal to the thickness direction (axis direction) is arranged near the voice coil 31, a comparatively large static magnetic field (DC magnetic field) MD1 is generated in a magnetic gap. As such, the speaker device 1K can emit a sound wave with a high sound quality by a comparatively large sound pressure.

### Eleventh Embodiment

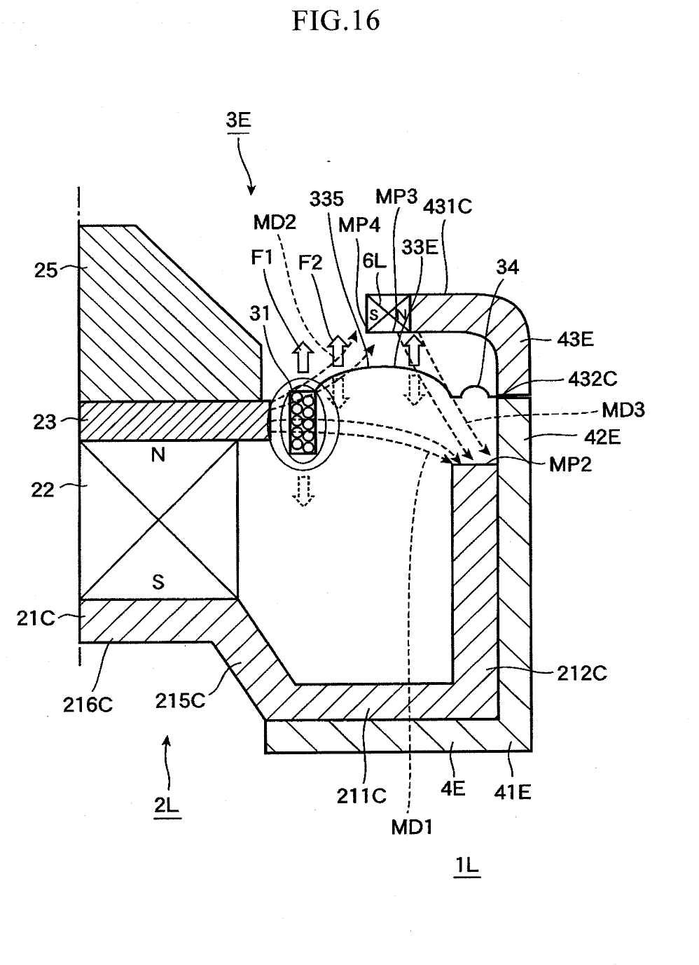

FIG. 16 is a cross-sectional view of the speaker device 1L according to eleventh embodiment of the present invention. Descriptions for the same configurations as the sixth embodiment shown in FIG. 11 are omitted. The half left part of the axisymmetrically-formed speaker device 1L is omitted in FIG. 16.

As shown in FIG. 16, the speaker device 1L according to this embodiment includes a magnet 6L. The magnet 6L is arranged above the vibrating body 3E. Specifically, magnet 6L is arranged, for example, substantially at the middle part between the plate 23 and the outer periphery side part 212C of the yoke 21C in the radial direction and at a position higher than the plate 23 (in the side of sound emission direction SD). This magnet 6L is magnetized in a direction orthogonal to the thickness direction (axis direction).

The above speaker device 1L includes the above magnet 6L. lines of magnetic force (DC magnetic field)MD2 and lines of magnetic force (DC magnetic field) MD3 are comparatively large in magnitude compared to the sixth embodiment. As such, the speaker device 1L can emit a sound wave with a high sound quality by a comparatively large sound pressure.

### Twelfth Embodiment

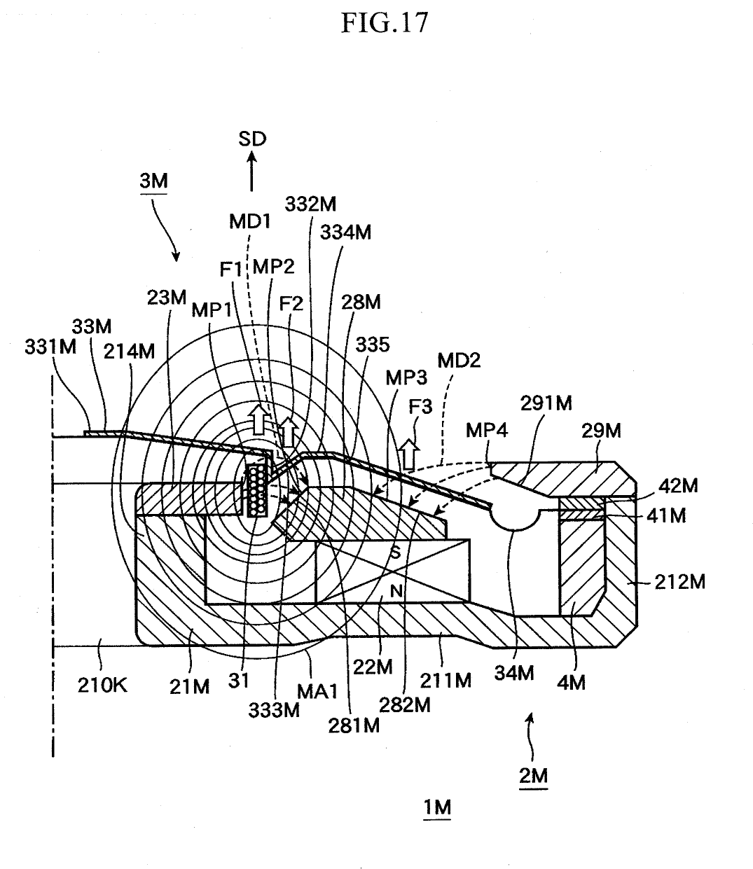

FIG. 17 is a cross-sectional view of the speaker device 1M according to a twelfth embodiment of the present invention. Descriptions for the same configurations as the first embodiment to the eleventh embodiment are omitted. The half left part of the axisymmetrically-formed speaker device 1M is omitted in FIG. 17.

As shown in FIG. 17, the speaker device 1M according to the twelfth embodiment of the present invention includes the magnetic circuit 2M and the vibrating body 3M.

The magnetic circuit 2M according to this embodiment is arranged above the vibrating body 3M and includes a magnetic pole part MP4 formed with a magnetic body. The magnetic pole part MP4 is arranged outside of the voice coil 31 in a radial direction.

Specifically, as shown in FIG. 17, the magnetic circuit 2M includes a yoke 21M, a magnet 22M, a plate (pole piece) 23M, a plate 28M and a plate 29M. The plate 23M corresponds to an embodiment of a first magnetic pole part according to the present invention, the plate 28M corresponds to an embodiment of a second magnetic pole part according to the present invention and the plate 29M corresponds to an embodiment of a third magnetic pole part according to the present invention.

The yoke 21M includes a bottom face part 211M, outer periphery side part 212M (tubular part) and a pole part 214M. a pole part 214M is formed at the central part the bottom face part 211M. The pole part 214 has an opening 210K formed with a diameter smaller than the outer diameter of the pole part 214. Although the bottom face part 211M, the outer periphery side part 212M (tubular part) and the pole part 214M are integrally formed with a magnetic body, such as iron, they may be formed with different members.

The magnet 22M is annularly formed and arranged on the bottom face part 211M of the yoke 21M. The magnet 22M is magnetized in the axis direction (thickness direction). The plate (pole piece) 23M is annularly formed and arranged on the pole part 214M of the yoke 21M. The plate 23M is formed larger in the outer diameter than the pole part 214M.

The plate 28M is arranged on the magnet 22M. Specifically, the plate 28M is formed in a substantially rectangular cross-sectional shape in the radial direction. a first slant face part 281M is formed in an inner side of the upper face part of the plate in the radial direction. And a second slant face part 282M is formed in an outer side of the upper face part in the radial direction. These first slant face part 281M and second slant face part 282M have shapes prescribed in response to the shape of the diaphragm 33M and the static magnetic field, etc.

The plate 29M is annularly formed and arranged on the outer periphery side part 212M of the yoke 21M. The plate 29M has a slant face part 291M formed at the lower end portion of the inner periphery part of the plate. This slant face part 291M is prescribed in response to the shapes of the diaphragm 33M, the static magnetic field, etc.

The plate 23M includes a first magnetic pole part MP1 and the plate 28M includes a second magnetic pole part MP2 and a third magnetic pole part MP3. The plate 29M includes a fourth magnetic pole part MP4.

A curved line or curved lines of magnetic force (DC magnetic field) MD1 are formed in a magnetic gap between the plate 23M and the plate 28M. A curved line or curved lines of magnetic force (DC magnetic field) MD2 are formed in a magnetic gap between the plate 28M and the plate 29M.

The vibrating body 3M includes a voice coil 31, a diaphragm 33M and edge 34M. The voice coil 31 is arranged in the magnetic gap between the plate 23M and the plate 28M and vibratably supported by a diaphragm 33M.

The diaphragm 33M includes a first vibrating part 334M, a second vibrating part 331M, a tubular part 332M and a conducting part 335.

The first vibrating part 334M is annularly formed and the outer periphery part of the first vibrating part is supported by the support member 4M via the edge 34M. Further, the first vibrating part 334M has a radially cross-sectional shape formed in a convex shape in the sound emission direction SD. The first vibrating part 334M is formed in a shape substantially following the magnetic flux line (static magnetic field MD1 and MD2).

The second vibrating part 331M is formed in substantially a dome shape and arranged inside the first vibrating part 334M.

The tubular part 332M is arranged between the first vibrating part 334M and the second vibrating part 331M and the upper end portion of the tubular part is connected to the outer periphery end of the second vibrating part 331M and the lower end portion of the tubular part is connected to the inner periphery part of the first vibrating part 334M, and the voice coil 31 is connected to the rear face of the inner periphery part. Further, the tubular part 332M includes a rising part between the upper end portion and the lower end portion, and the voice coil is supported by the rising part. The tubular part 332M may connect the voice coil 31 to the front face of the inner periphery part as necessary. The voice coil 31 is arranged in a magnetic gap between the plate 23M and the plate 28M. This tubular part 332M corresponds to a voice coil support part supporting the voice coil 31 at the inside of the annular first vibrating part 334. The first vibrating part 334M, the second vibrating part 331M and the tubular part 332M are integrally formed, for example, with a nonconducting body such as paper, resin, etc.

The conducting part 335 according to this embodiment is annularly formed at the first vibrating part 334M, the second vibrating part 331M and the tubular part 332M.

The conducting part 335 is not limited to the above embodiment. For example, the diaphragm 33M may include the conducting part 335 by forming the diaphragm 33M itself with a conducting material.

The edge 34M is, for example annularly formed, and the inner periphery part the edge is connected to the diaphragm 33M, while the outer periphery part of the edge is connected to the support member 4M directly or via middle part members 41M and 42M. Further, the edge 34M may be a third vibrating part emitting a sound wave.

An operation of the above speaker device 1M is described.

In the above speaker device 1M, upon a signal current inputted to the voice coil 31, a Lorentz force is generated at the voice coil 31 in response to the signal current. The voice coil 31 is vibrated in the axis direction (sound emission direction SD) of the voice coil 31 by the Lorentz force as a driving force F1 (first driving force). The driving force F1 (first driving force) generated at the voice coil 31 is transmitted to the diaphragm 33M via the connecting part connecting the voice coil 31 and the diaphragm 33M and the diaphragm 33M is vibrated in response to the driving force F1 (first driving force).

Further, as shown in FIG. 17, in the speaker device 1M, when driving the speaker, upon a signal current (AC current) inputted to the voice coil 31, an alternating magnetic field MA1 (alternating magnetic flux) is generated around the voice coil 31. An electromagnetic induction is generated at the annular conducting part 335 of the diaphragm 33M due to the alternating magnetic field MA1, and an induction current is generated at the conducting part 335, and thus a driving force F2 (second driving force) in response to the DC magnetic field MD1 and the induction current in the magnetic gap and a driving force F2 (third driving force) in response to the DC magnetic field MD2 and the induction current in the magnetic gap, is generated at the conducting part 335 of the diaphragm 33M.

This driving force F2 and F3 are directed substantially in the same direction as the Lorentz force (first driving force F1) generated at the voice coil 31.

As such, according to the speaker device 1M, since the diaphragm 33C is driven by the driving force F1, F2 and F3 substantially in the same phase, the speaker device 1M can emit a sound wave with a high sound quality by a high sound pressure.

Further, the speaker device 1M can be made comparatively thin as shown in FIG. 17.

### Thirteenth Embodiment

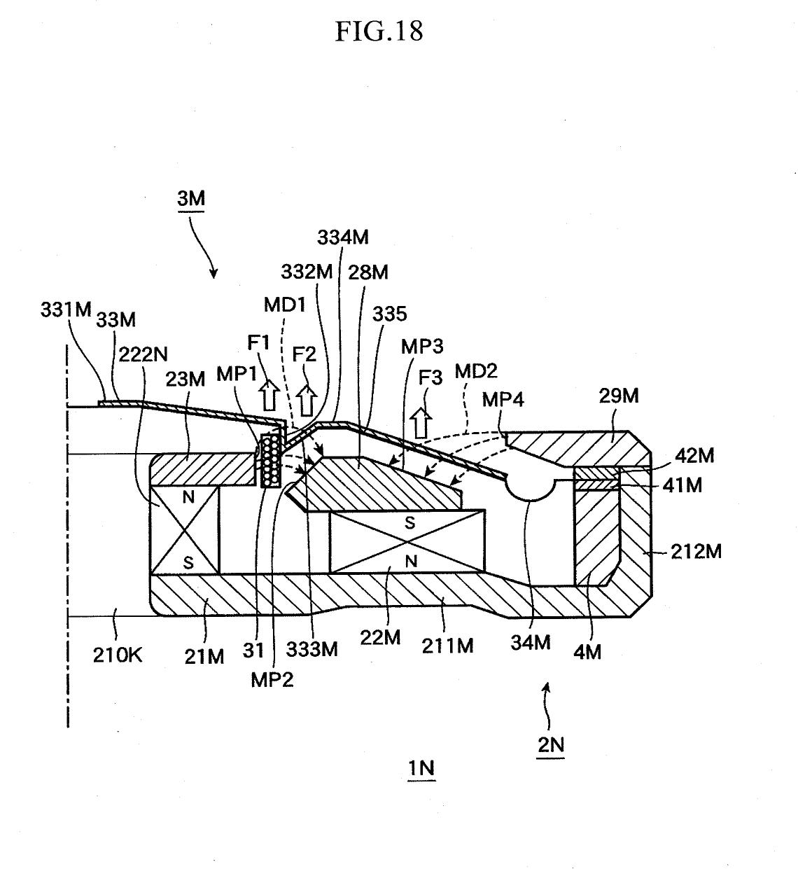

FIG. 18 is a cross-sectional view of the speaker device 1N according to a thirteenth embodiment of the present invention. Descriptions for the same configurations as the twelfth embodiment are omitted. The half left part of the axisymmetrically-formed speaker device 1N is omitted in FIG. 18.

As shown in FIG. 18, the speaker device 1N includes a magnetic circuit 2N and the vibrating body 3M. The magnetic circuit 2N includes an annular first magnet 22M and an annular second magnet 222N. The magnet 222N is annularly formed and the diameter of the magnet 222N is formed smaller than the first magnet 22M. Further the magnet 222N is magnetized along the thickness direction (axis direction) in a direction opposite to the magnetization direction of the first magnet 22M. This magnet 222N corresponds to the pole part 214M according to the twelfth embodiment.

The above speaker device 1N including the annular first magnet 22M and the annular second magnet 222N, the lines of magnetic force (DC magnetic field)MD1 is larger than the twelfth embodiment. As such, the speaker device 1N can emit a sound wave with a high sound quality by a high sound pressure, for example, compared to the twelfth embodiment.

### Fourteenth Embodiment

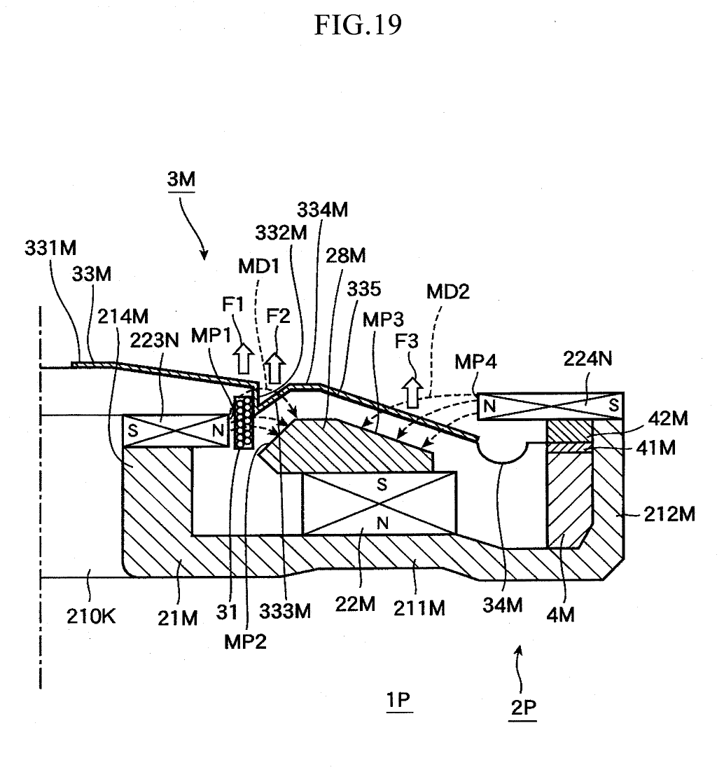

FIG. 19 is a cross-sectional view of the speaker device 1P according to a fourteenth embodiment of the present invention. Descriptions for the same configurations as the twelfth and thirteenth embodiments are omitted. The half left part of the axisymmetrically-formed speaker device 1P is omitted in FIG. 19.

As shown in FIG. 19, the speaker device 1P includes a magnetic circuit 2P and the vibrating body 3M. The magnetic circuit 2P includes an annular first magnet 22M, an annular second magnet 223N and an annular third magnet 224N. The second magnet 223N corresponds to the plate 23M according to the twelfth embodiment shown in FIG. 18. The third magnet 224N corresponds to the plate 29M according to the twelfth embodiment shown in FIG. 18.

The second magnet 223N is annularly formed and magnetized in the direction orthogonal to the thickness direction (axis direction).

The third magnet 224N is annularly formed and magnetized in the direction orthogonal to the thickness direction (axis direction). The third magnet 224N is magnetized in the direction opposite to magnetization direction of the second magnet 223N.

Further, according to the magnetic circuit 2P, the pole (N pole) in the outer periphery side of the second magnet 223N and the pole (N pole) in the inner periphery side of the third magnet 224N are arranged opposite to each other. The magnet 22M is magnetized so that the pole (S pole) of the upper end portion is in opposite to the pole (N pole) in the outer periphery side of the second magnet 223N.

The above speaker device 1P including the annular first magnet 22M and the annular second magnet 223N and the annular third magnet 224N, the lines of magnetic force (DC magnetic field) MD1 and MD2 are larger than the twelfth embodiment. Thus, the speaker device 1P can emit a sound wave with a high sound quality by a high sound pressure, for example, compared to the twelfth embodiment. The second magnet 223N may be magnetized in an oblique direction with respect to a horizontal direction toward the magnetic pole part MP2 of the plate 28M as necessary. Also, the third magnet 224N may be magnetized in an oblique direction with respect to a horizontal direction toward the magnetic pole part MP3 of the plate 28M. Further, the above magnet magnetized in the oblique direction may be adopted not limited to this embodiment.

### Fifteenth Embodiment

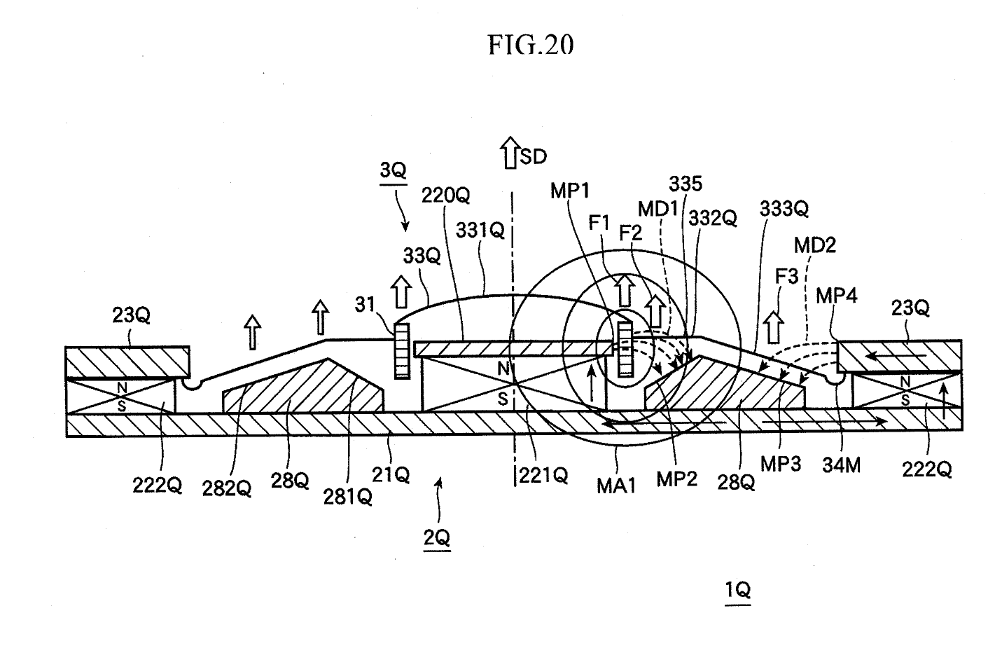

FIG. 20 is a cross-sectional view of the speaker device 1Q according to a fifteenth embodiment of the present invention. Descriptions for the same configurations as the twelfth to fourteenth embodiments are omitted.

As shown in FIG. 20, the speaker device 1Q according to this embodiment includes a magnetic circuit 2Q and the vibrating body 3Q. The magnetic circuit 2Q includes a yoke 21Q, a first magnet 221Q, a second magnet 222Q, a plate 220Q, a plate 23Q and an annular convex shape part 28Q. The yoke 21Q is tabularly formed as shown in FIG. 20. The first magnet 221Q is arranged on the central part of the yoke 21Q and magnetized in the axis direction (thickness direction or sound emission direction SD). The plate 220Q is tabularly formed and arranged on the first magnet 221Q. The second magnet 222Q is annularly formed, and prescribed larger in the diameter than the first magnet 221Q. Further, the second magnet 222Q is magnetized along the thickness direction. The magnetization direction of this second magnet 222Q is the similar to the magnetization direction of the first magnet 221Q. The plate 23Q is annularly formed and arranged on the second magnet 222Q.

The annular convex shape part 28Q is annularly formed and arranged between the first magnet 221Q and the second magnet 222Q. Specifically, as shown in FIG. 20, the annular convex shape part 28Q includes a first slant face part 281Q and a second slant surface 282Q. The first slant face part 281Q is formed in an inner side of the upper face portion of the annular convex shape part 28Q in the radial direction. And the second slant surface 282Q is formed in an outer side of the upper face portion of the annular convex shape part 28Q in the radial direction. The shapes of the first slant face 281Q and the second slant face 282Q are prescribed in response to the shape of the diaphragm 33Q and the static magnetic field, etc. This annular convex shape part 28Q and the yoke 21Q may be integrally molded, for example, with a magnetic body such as iron, etc. or may be formed with different members.

The plate 220Q corresponds to the first magnetic pole part MP1. The annular convex shape part 28Q includes the second magnetic pole part MP2 and the third magnetic pole part MP3. The plate 23Q corresponds to the fourth magnetic pole part MP4. A static magnetic field (DC magnetic field) MD1 is formed between the plate 220Q and the annular convex shape part 28Q. A DC magnetic field (DC magnetic field) MD2 is formed between the annular convex shape part 28Q and the plate 23Q.

The vibrating body 3Q includes a voice coil 31, a diaphragm 33Q and an edge 34M. The diaphragm 33Q includes a first vibrating part 332Q and a second vibrating part 331Q. For example, the first vibrating part 332Q of the diaphragm 33Q includes a conducting part 335. The first vibrating part 332Q has an inner periphery part and an outer periphery part. The inner periphery part of the first vibrating part 332Q is connected to the voice coil 31. The outer periphery part of the first vibrating part 332Q is supported by the magnetic circuit 2 via the edge 34M. Further, the first vibrating part 332Q includes a slant face 333Q from a central part to outside in the radial direction. This slant face 333Q is formed in a shape substantially following the lines of magnetic force (static magnetic field) MD1 and MD2.

The second vibrating part 331Q is formed in a dome shape and arranged inside the first vibrating part 332Q. Further, the second vibrating part 331Q according to this embodiment has an outer periphery part connected to the upper end portion of the voice coil 31. Further, the first vibrating part 332Q or the second vibrating part 331Q includes a voice coil support part and the voice coil 31 is supported by the coil support part. According to this embodiment, the voice coil 31 is connected to the inner side face of the voice coil support part. The voice coil support part may be formed as a rising part having a rising shape between the first vibrating part 332Q and the second vibrating part 331Q, and the voice coil 31 may be supported by the outer side face of the voice coil support part as necessary. The configurations of the voice coil 31 and the voice coil support part are not limited to this embodiment, and other embodiments may be applied as necessary.

An operation of the above speaker device 1Q is substantially the same as the speaker device 1M according to the twelfth embodiment shown in FIG. 17, and thus it is omitted here.

The above speaker device 1Q, having a comparatively simple configuration, can emit a sound wave with a high sound quality by a comparatively high sound pressure compared to the speaker devices according to the fourteenth embodiment from the twelfth embodiment. The speaker device 1Q can be made comparatively thin as shown in FIG. 20.

### Sixteenth Embodiment

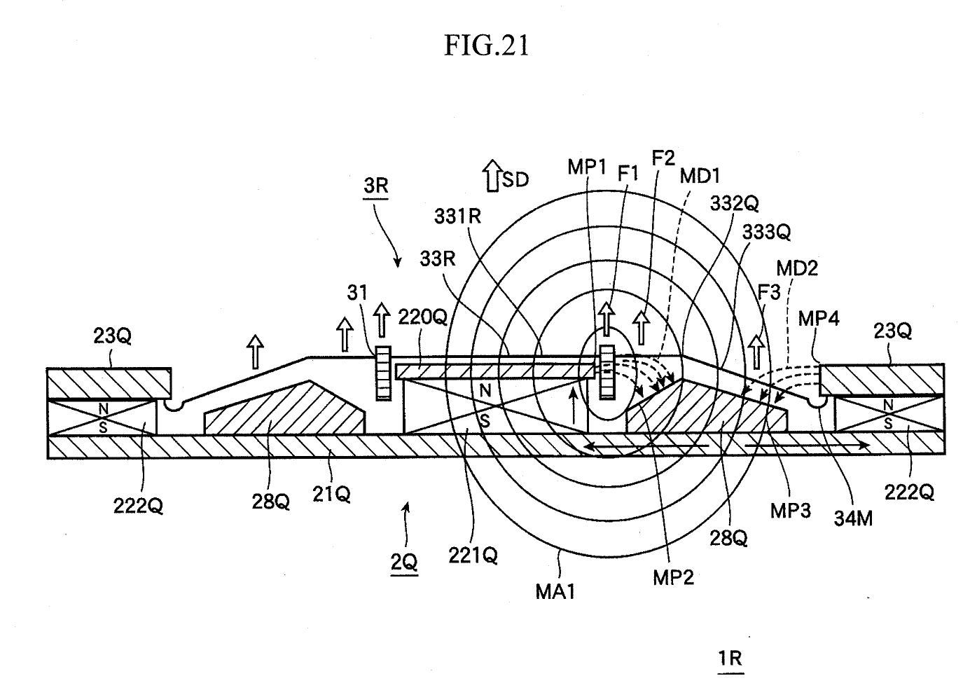

FIG. 21 is a cross-sectional view of the speaker device 1R according to a sixteenth embodiment of the present invention. Descriptions for the same configuration as the fifteenth embodiment are omitted. The speaker device 1R includes a magnetic circuit 2Q and a vibrating body 3R. The vibrating body 3R includes a diaphragm 33R. The diaphragm 33R includes a first vibrating part 332Q and a second vibrating part 331R. The second vibrating part 331R is tabularly formed and arranged inside the first vibrating part 332Q. Further, the second vibrating part 331R according to this embodiment has an outer periphery part connected to the inner periphery part of the voice coil 31.

The above speaker device 1R, including a tabular second vibrating part 331R, can be made comparatively thin compared to the speaker device 1Q according to the fifteenth embodiment.

### Seventeenth Embodiment

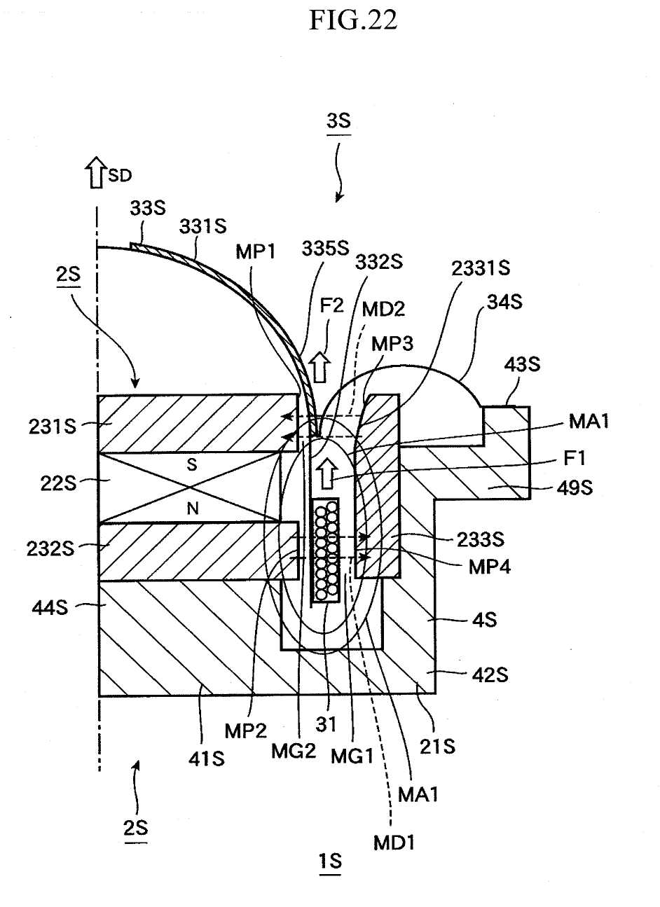

FIG. 22 is a cross-sectional view of the speaker device 1S according to a seventeenth embodiment of the present invention. Descriptions for the same configurations as the first to the sixteenth embodiments are omitted. The half left part of the axisymmetrically-formed speaker device 1S is omitted in FIG. 22.

As shown in FIG. 22, the speaker device 1S includes a magnetic circuit 2S, a vibrating body 3S and a frame 4S. The magnetic circuit 2S includes a magnet 22S, a first plate 231S, a second plate 232S and a magnetic body 233S. The first plate 231S corresponds to an embodiment of the first magnetic pole part according to the present invention. The second plate 232S corresponds to an embodiment of the second magnetic pole part according to the present invention. The magnetic body 233S corresponds to an embodiment of the third magnetic pole part and the fourth magnetic pole part according to the present invention.

The first plate 231S is formed, for example, in a plate shape such as a disk shape and arranged at the upper part of the magnet 22S. The second plate 232S is formed, for example, in a plate shape such as a disk shape and arranged at the lower part of the magnet 22S. In short, the magnet 22S is arranged between the first plate 231S and the second plate 232S. The first plate 231S and the second plate 232S are substantially same in the outer diameter. The first plate 231S and the second plate 232S are larger than the magnet 22S in the outer diameter.

Further, the magnetic body 233S is formed, for example, substantially in a tubular shape. The magnetic body 233S faces the side faces of said first magnetic pole part and second magnetic pole part. The magnetic body 233S is arranged apart from the side faces of said first magnetic pole part and second magnetic pole part by a prescribed distance.

Further, for example, the inner diameter of the magnetic body 233S is formed larger than the outer diameters of the first plate 231S and the second plate 232S. The magnetic body 233S is formed in a shape in which the lower end portion is positioned at substantially the same height as vincity of the lower end of the second plate 232S and the upper end portion is positioned at substantially the same height as vincity of the upper end portion of the first plate 231S as shown in FIG. 22. Further, the magnetic body 233S includes a slant face 2331S inside of an upper end portion of the magnetic body.

The magnetic gap formed between the first magnetic pole part MP1 (first plate 231S) and the third magnetic pole part MP3 (magnetic body 233S) and the magnetic gap formed between the second magnetic pole part MP2 (second plate 232S) and the fourth magnetic pole part MP4 (magnetic body 233S) communicate with each other.

A static magnetic field (DC magnetic field) MD2 is formed between the first magnetic pole part MP1 (first plate 231S) and the third magnetic pole part MP3 (magnetic body 233S). A static magnetic field (DC magnetic field) MD1 is formed between the second magnetic pole part MP2 (second plate 232S) and the fourth magnetic pole part MP4 (magnetic body 233S).

The vibrating body 3S includes a voice coil 31 and a diaphragm 33S. The voice coil 31 is arranged in a first magnetic gap MG1 formed between the second magnetic pole part (second plate 232S) and the third magnetic pole part (magnetic body 233S).

The diaphragm 33S includes a first vibrating part 331S, a second vibrating part (edge) 34S, a voice coil support part 332S and a conducting part 335S.

The first vibrating part 331S is formed in a dome shape and the outer periphery part is connected to the inner periphery part of the second vibrating part 34S as shown in FIG. 22. The outer periphery part of the second vibrating part 34S is connected to the frame 4S.

Further, the second vibrating part 34S according to this embodiment is annularly formed and is formed in a shape so as to surround the first vibrating part 331S. Further, the second vibrating part 34S has the radially cross-sectional shape formed in a convex shape in the sound emission direction SD, and arranged so as to go over an upper part of the magnetic body 233S.

The voice coil support part 332S is tubularly formed and the upper end portion of the voice coil support part 332S is connected between the first vibrating part 331S and the second vibrating part 34S, the position near the central part of the tubular part is arranged so as to pass between the first magnetic pole part (first plate 231S) and the magnetic body 233S. The lower end portion of the voice coil support part 332S is formed so as to position at the height near the second plate 232S. Further, the voice coil 31 is provided near the lower end portion of the voice coil support part 332S. In short, the voice coil 31 is arranged at substantially the same height as the second magnetic pole part (second plate 232S).

The conducting part 335S is formed at a position near the voice coil 31, in the second magnetic gap MG2 between the first magnetic pole part (first plate 231S) and the third magnetic pole part (magnetic body 233S). The conducting part 335S is formed on a part or whole of the vibrating body 3S.

Specifically, the lower end portion of the conducting part 335S is formed to a vincity of the lower end portion of the first plate 231S.

The frame 4S is, for example, formed with non-conducting body such as resin, etc. Specifically, the frame 4 includes a bottom face part 41S, a tubular part 42S, an upper end portion 43S, a flat part 49S and a center projection part 44S as shown in FIG. 22.

In the frame 4, the tubular part 42S is connected to the outer periphery end portion of the bottom face part 41S and the magnetic body 233S (third magnetic pole part MP3) is provided in the proximity of the upper part of the inner face of the frame. Further in the frame 4, the flat part 49S is formed outward in the radial direction at the upper part of the tubular part 42S. The flame 4 is formed in a shape extending toward the sound emission direction SD from the outer periphery part of the flat part 49S. The outer periphery end of the second vibrating part 34S (edge) is connected to the upper end portion 43S of the frame 4. Further, in the frame 4, the center projection part 44S is provided at the bottom face part 41S and the magnetic circuit 2S (second plate 232S) is provided on the center projection part 44S. In the above frame 4, although the bottom face part 41S, the tubular part 42S, the upper end portion 43S, the flat part 49S and the center projection part 44S are integrally formed, for example, with a forming material such as resin, etc. They may be formed with different members.

An operation of the above speaker device 1S is described.

According to the above speaker device 1, when driving the speaker, upon a signal current inputted to the voice coil 31, a Lorentz force is generated at the voice coil 31 in response to the signal current. The voice coil 31 is vibrated in the axis direction (sound emission direction SD) of the voice coil 31 by the Lorentz force as a driving force F1 (first driving force). The driving force F1 (first driving force) generated at the voice coil 31 is transmitted to the diaphragm 33S via the voice coil support part 332S between the voice coil 31 and the diaphragm 33S, and the diaphragm 33S is vibrated in response to the driving force F1 (first driving force).

Further, as shown in FIG. 22, in the speaker device 1S, when driving the speaker, upon a signal current (AC current) inputted to the voice coil 31, an alternating magnetic field MA1 (alternating magnetic flux) is generated around the voice coil 31. An electromagnetic induction is generated at the annular conducting part 335 of the diaphragm 33S due to the alternating magnetic field MA1, and an induction current (Al) is generated in the conducting part 335 as shown in FIG. 3(B), and thus a driving force F2 (second driving force) is generated at the conducting part 335 of the diaphragm 33S in response to the DC magnetic field MD2 and the induction current in the magnetic gap MG1. This driving force F2 (second driving force) is directed substantially in the same direction as the Lorentz force (first driving force F1) generated at the voice coil 31.

The above speaker device 1S includes: the vibrating body 3S having the diaphragm 33S and the voice coil 31 supported by a part of the diaphragm 33S; and the magnetic circuit 2S in which the first and the second magnetic pole parts (first plate 231S and second plate 232S) formed at both end portions of the magnet 22S and the third and the fourth magnetic pole parts (magnetic body 233S) that are different from the first and the third and the fourth magnetic pole parts are arranged spaced apart. The voice coil 31 is arranged between the second magnetic pole part (second plate 232) and the fourth magnetic pole part (magnetic body 233S). In the vibrating body 3S, the conducting part 335S is formed on a part or whole of the diaphragm 33S in the proximity of the voice coil 31. Since the conducting part 335S is arranged between the first magnetic pole part (first plate 231S) and the third magnetic pole part (magnetic body 233S), the diaphragm 33S can emit a sound wave with a high sound quality by a comparatively high sound pressure in response to the driving force F1 and the driving force F2.

That is, the speaker device 1S includes the magnetic circuit 2S, which includes the magnet 22S, the first magnetic pole part (first plate 231S) arranged at the upper part of the magnet 22S, the second magnetic pole part (second plate 232S) arranged at the lower part of the magnet 22S and the third magnetic pole part (magnetic body 233S) facing the side faces of the first magnetic pole part and the second magnetic pole part, spaced apart by a prescribed distance. The voice coil 31, is arranged in the first magnetic gap MG1 formed between the second magnetic pole part and the third magnetic pole part. The conducting part 335S is formed at a part or whole of the diaphragm 33S in the proximity of the voice coil 31, in the magnetic gap MG2 formed between the first magnetic pole part and the third magnetic pole part. Thus, the diaphragm 33S can emit a sound wave with a high sound quality by a comparatively high sound pressure in response to the driving force F1 and the driving force F2.

As described above, the speaker device 1 according to the present invention includes the vibrating body 3 including the diaphragm 33 and the voice coil 31 supported by a part of the diaphragm 33; and the magnetic circuit 2 in which the first magnetic pole part MP1 (plate 23) including the magnet 22 and the second magnetic pole part MP2 (yoke 21) including the magnetic pole different from the first magnetic pole part MP1 (plate 23) are arranged spaced apart; and the voice coil 31 is arranged between the first magnetic pole part MP1 and the second magnetic pole part MP2, and the vibrating body 3 includes the conducting part 335 formed at a part or whole of the diaphragm 33 in the proximity of the voice coil 31, and the conducting part 335 is arranged between the first magnetic pole part MP1 and the second magnetic pole part MP2. Thus, the diaphragm 33 and the voice coil 31 can vibrate substantially in the same phase. In addition, the speaker device according to the present invention can emit a sound wave with a high sound quality by a comparatively high sound pressure.

The present invention is not limited to the above embodiments. For example, each of the embodiments may be combined. Further, the diaphragm may be provided inside of the voice coil 31. Further, the conducting part may be provided inside of the voice coil.

The speaker device according to the present invention can be applied to, for example, an acoustic device such as a speaker system for a vehicle, a headphone, a mobile phone, an audio system, a mobile player, etc.

1. A speaker device, comprising:
a vibrating body including a diaphragm and a voice coil supported by a part of the diaphragm; and
a magnetic circuit including a first magnetic pole part having a magnet and a second magnetic pole part different from the first magnetic pole part and arranged spaced apart from the first magnetic pole part; wherein
said voice coil is arranged between said first magnetic pole part and said second magnetic pole part,
said vibrating body includes a conducting part formed at a part or whole of said diaphragm, in the proximity of said voice coil, and
said conducting part is arranged between said first magnetic pole part and said second magnetic pole part.

2. The speaker device according to claim 1, wherein
said voice coil is formed in a shape extending in the vibration direction of said diaphragm, and
said conducting part has a cross-sectional shape formed in a shape substantially along a line of magnetic force passing through between said first magnetic pole part and second magnetic pole part.

3. The speaker device according to claim 2, wherein
said diaphragm has said conducting part arranged radially outside of said voice coil in the proximity of the voice coil, and the conducting part is annularly formed in the circumferential direction.

4. The speaker device according to claim 3, wherein
said diaphragm has said conducting part formed in a face distributed shape with a prescribed width in a radial direction of the diaphragm.

5. The speaker device according to claim 4, comprising a frame supporting said vibrating body, wherein
said vibrating body includes a diaphragm support part formed between the outer periphery part of said diaphragm and said frame, and
said diaphragm is vibratably supported by said frame via said diaphragm support part.

6. The speaker device according to claim 3, wherein
said magnetic circuit is arranged above said vibrating body, and
said magnetic circuit includes a magnetic body, wherein
a magnetic gap is constructed between said magnetic body and said first magnetic pole part and between said magnetic body and said second magnetic pole part.

7. The speaker device according to claim 3, wherein
said magnetic circuit includes a third magnetic pole part, wherein
said third magnetic pole part is arranged above said vibrating body and is formed with a magnetic body, and
said third magnetic pole part is arranged radially outside of said voice coil bobbin.

8. The speaker device according to claim 7, wherein
said vibrating body includes a first voice coil and a second voice coil having an outer diameter that is larger than an outer diameter of said first voice coil, and
said second voice coil is arranged between said magnetic body arranged above said diaphragm and said first or second magnetic pole part of said magnetic circuit.

9. The speaker device according to claim 3, comprising a frame supporting said vibrating body, wherein
said frame is annularly formed with an outer diameter larger than the outer diameters of said first magnetic pole part and said second magnetic pole part, and
said vibrating body extends to said frame beyond said second magnetic pole part.

10. The speaker device according to claim 3, wherein
a magnetic fluid is arranged between the inner side of said voice coil and a magnetic pole part arranged in the inner side of said voice coil.

11. The speaker device according to claim 1, comprising a diaphragm support part supporting said vibrating body, a frame and a damper, wherein
said diaphragm includes an outer periphery part and an inner periphery part, wherein
said outer periphery part of said diaphragm is supported by the frame via the diaphragm support part, and
said inner periphery part of said diaphragm is supported by said magnetic pole part arranged in the inner side of said voice coil via the damper.

12.-16. (canceled)

17. The speaker device according to claim 1, comprising a frame supporting said vibrating body, wherein
said frame has an annular shape having an outer diameter larger than the outer diameters of said first magnetic pole part and said second magnetic pole part,
said conducting part is arranged on said diaphragm, and
said diaphragm includes a first vibrating part and a second vibrating part wherein
said first vibrating part is formed in an annular shape, and
said second vibrating part is formed inside said first vibrating part.

18. (canceled)

19. The speaker device according to claim 1, wherein
said magnetic body forming said first magnetic pole part or said second magnetic pole part includes a bottom face part and an outer periphery side part surrounding said bottom face part.

20. The speaker device according to claim 1, wherein
said magnetic body forming said first magnetic pole part or said second magnetic pole part includes a bottom face part and a projecting part projecting from said bottom face part.

21. The speaker device according to claim 1, wherein
said vibrating body includes a diaphragm support part connected to an end portion of said diaphragm and vibratably supporting said diaphragm, and
said diaphragm support part includes an insulating material.

22. A speaker device, comprising:
a vibrating body including a diaphragm and a voice coil supported by a part of said diaphragm; and
a magnetic circuit including a first and a second magnetic pole parts and a third and a forth magnetic pole parts different from said first and said second magnetic pole parts, wherein
said first and said second magnetic pole parts are formed at both ends of a magnet, and
said first and second magnetic pole parts are arranged spaced apart, wherein
said voice coil is arranged between said second magnetic pole part and said fourth magnetic pole part, and
said vibrating body includes a conducting part formed at a part or whole of said diaphragm, in the proximity of said voice coil, and
said conducting part is arranged between said first magnetic pole part and said third magnetic pole part.

23. The speaker device according to claim 22, wherein
said diaphragm includes a first vibrating part and an annular second vibrating part formed in the outer periphery side of said first vibrating part, and
a magnetic gap formed between the first magnetic pole part and the third magnetic pole part and a magnetic gap formed between the second magnetic pole part and the third magnetic pole part communicate with each other, and
a part of said diaphragm is arranged in said magnetic gap,
one end of said diaphragm is connected to said voice coil arranged between said second magnetic pole part and said fourth magnetic pole part, and
another end of the diaphragm has said voice coil support part connected between said first vibrating part and said second vibrating part.

24. The speaker device according to claim 23, wherein
said voice coil is arranged substantially at the same height as said second magnetic pole part.

25. A vehicle, comprising said speaker device according to claim 1.

26. An acoustic device, comprising said speaker device according to claim 1.
